(19) United States
(12) Patent Application Publication
(10) Pub. No.: US 2009/0078401 A1
(43) Pub. Date: Mar. 26, 2009

(54) INTEGRATION OF AN INTERNET-SERVING DATACENTER WITH A THERMAL POWER STATION AND REDUCING OPERATING COSTS AND EMISSIONS OF CARBON DIOXIDE

(76) Inventor: J. Edward Cichanowicz, Saratoga, CA (US)

Correspondence Address: ROBERT K. CARPENTER, 5 PIPESTEM COURT, ROCKVILLE, MD, 20854, US

(21) Appl. No.: 12/131,117

(22) Filed: Jun. 1, 2008

Related U.S. Application Data
(60) Provisional application No. 60/960,308, filed on Sep. 25, 2007.
(60) Provisional application No. 60/996,484, filed on Nov. 20, 2007.

(51) Int. Cl. G05D 23/00; F28D 15/00; F25D 17/02

(52) U.S. Cl. 165/299; 165/300; 165/104.13; 165/104.33; 62/259.2

(57) ABSTRACT

Methods, systems and apparatus for combining a thermal power plant with at least one data center.

### CROSS-REFERENCE TO RELATED APPLICATIONS

This application claims priority to U.S. provisional patent applications Nos. 60/996,484 filed Nov. 20, 2007, and 60/960,308 filed Sep. 25, 2007, the subject matter of both of which is hereby incorporated herein by references in their entireties.

### STATEMENT REGARDING FEDERALLY SPONSORED RESEARCH OR DEVELOPMENT

(Not Applicable)

### THE NAMES OF THE PARTY TO A JOINT RESEARCH AGREEMENT

(Not Applicable)

### INCORPORATION-BY-REFERENCE OF MATERIAL SUBMITTED ON A COMPACT DISC

(Not Applicable)

### BACKGROUND OF THE INVENTION

(1) Field of the Invention

This disclosure is directed to methods, systems, and apparatus for the integration of an internet-serving datacenter with a thermal power station and for reducing operating costs and emissions of carbon dioxide.

(2) Description of Related Art Including Information Submitted under 37 CFR 1.97 and 1.98

Whitted (U.S. Pat. No. 7,278,273) discloses modular data centers, utilizing air-based heat exchangers to remove heat, can be configured with either or both a modular power generation equipment, or modular cooling towers.

### BRIEF SUMMARY OF THE INVENTION

At least some aspects of this disclosure are directed to methods, systems, and apparatus for the integration of an internet-serving data center with a thermal power station and for reducing operating costs and emissions of carbon dioxide.

More particularly, aspects of this disclosure are directed to methods, systems and apparatus for combining a thermal power plant with at least one data center.

Even more particularly, at least some aspects and embodiments of this disclosure are directed to methods, systems, and/or apparatus for cooling a data center, including: diverting a portion of cooling water acquired by a thermal power station intake structure from a body of water; and passing the diverted portion of cooling water through at least one heat exchanger to cool heat rejected by at least one data center. In at least some embodiments, the diverting is only conducted when a cooling water flow rate or temperature prior to the diverting is in excess of what is required for a boiler condenser to which a non-diverted portion of the cooling water is sent. Also in at least some embodiments, the at least one heat exchanger is at least one direct heat exchanger, where surfaces of the heat exchanger that reject data center heat are in direct contact with the diverted cooling water. Also in at least some embodiments, the at least one heat exchanger is at least one indirect heat exchanger, where surfaces of the heat exchanger that reject data center heat are in contact with a cooling media or cooling fluid that flows in a closed loop through a second heat exchanger, the diverted cooling water flowing through the second heat exchanger. Also in at least some embodiments, the diverting is only conducted during a portion of a year when the temperature of the cooling water to be diverted is less than a selected temperature to provide for data center cooling, utilizing either a direct or indirect heat exchanger; and during other portions of the year, when the temperature is above the selected temperature, the heat rejected by the at least one data center is cooled in a different manner. Also in at least some embodiments, the methods, systems and/or apparatus further include diverting the cooling water to at least one heat exchanger from an absorption chiller that utilizes as a heat source at least one of steam, heated water, and flue gas from combustion products, to remove heat from the at least one data center. Also in at least some embodiments, in the methods, systems and/or apparatus, at times when the temperature of the water acquired by the thermal power station inlet structure is sufficient in a direct or indirect heat exchanger, said temperature of the water being of a maximum of 75° F., and when the temperature of the water exceeds approximately 75° F., the water then used to accept heat rejected by an absorption chiller, configured to provide the cooling water to the data center. Also in at least some embodiments, the thermal power station is a coal-fired thermal power station. Also in at least some embodiments, the thermal power station is a fossil fuel-fired, renewable fuel-fired, geothermal, or nuclear fuel thermal power station.

Also at least some aspects and embodiments of this disclosure are directed to methods, systems, and/or apparatus of cooling a data center, including sending heat removed from a data center by an absorption chiller utilizing at least one heat exchanger to transfer heat to raise the temperature of steam boiler condensate water, the heat exchanger located following a boiler condenser and preceding an inlet to the boiler feedwater; and thereafter recycling the heat removed from the data center to the steam boiler for power generation.

At least some aspects and embodiments of this disclosure are directed to methods, systems, and/or apparatus for cooling a data center, including sending heat removed from a data center by an absorption chiller to either the effluent or inlet to the cooling tower, or an ancillary heat exchanger at a power plant site in contact with a cooling water body or another thermal generating unit at the power plant site.

At least some aspects and embodiments of this disclosure are directed to methods, systems, and/or apparatus for cooling a data center, including sending heat removed from a data center by an absorption chiller to either effluent or inlet to a cooling tower, or a heat exchanger in contact with cooling water located downstream of a boiler condenser.

At least some aspects and embodiments of this disclosure are directed to methods, systems, and/or apparatus for cooling a data center, including; utilizing a cooling tower configured for a thermal power station; and diverting cooling tower blowdown to the data center for cooling; utilizing either a direct heat exchanger on a once-through basis, or an indirect heat exchanger, with data center cooling provided by a recirculating cooling media and a second heat exchanger; and rejecting the cooling tower blowdown to the plant discharge pond or impoundment system. In at least some aspects and embodiments, the methods, systems, and/or apparatus further include: cooling the cooling tower blowdown with an absorption chiller, or utilizing cooling water chilled by the absorption chiller to supplement the cooling tower blowdown, the absorption chiller driven by steam or heated water or flue gas from the thermal power station; and rejecting heat to a stream either entering to or exiting from the cooling tower, or an ancillary heat exchanger in contact with a cooling water body. At least some embodiments further include cooling the cooling tower blowdown with an absorption chiller, or utilizing cooling water chilled by the absorption chiller to supplement the cooling tower blowdown, the absorption chiller driven by steam or heated water or flue gas from the thermal power station, and rejects heat to the condenser section or other heat exchangers of the steam boiler, the latter in a manner to return said heat to the steam cycle to contribute to power generation or unit thermal efficiency.

At least some aspects and embodiments of this disclosure are directed to methods, systems, and/or apparatus for cooling a data center, including; utilizing a cooling tower configured for a power station; and diverting a cooling stream or effluent from the cooling tower in transit to a boiler, when the marginal benefit provided by this quantity of cooling water in minimizing backpressure within the boiler condenser to improve plant output and thus thermal efficiency is small or counterproductive, or when said cooling water from the cooling tower is in excess in flow volume and/or temperature of what is required for the boiler condenser, said diverted cooling water utilized in at least one either direct or indirect heat exchanger to remove the heat rejected by a data center, this method minimizing or eliminating the penalty to thermal performance or output of the power station. At least some embodiments further include lowering the temperature of the cooling stream or effluent from the cooling tower with an absorption chiller that is driven by steam or heated water or flue gas from the thermal power station, or utilizing cooling water chilled by the absorption chiller to supplement the cooling tower effluent; and rejecting heat either to the cooling tower, or an ancillary heat exchanger at the plant site in contact with a cooling water body. At least some embodiments further include chilling the cooling tower effluent with an absorption chiller that is driven by steam or heated water or flue gas from the thermal power station, or utilizing cooling water chilled by the absorption chiller to supplement the cooling tower effluent; and rejecting heat to the condenser section or other heat exchangers of the steam boiler, the latter in a manner to return this heat to the steam cycle to contribute to power generation or unit thermal efficiency. At least some embodiments further include cooling the cooling tower effluent with an absorption chiller that is driven by steam or heated water or flue gas from the thermal power station, and rejecting heat to an ancillary heat exchanger located following the boiler condenser section.

At least some aspects and embodiments of this disclosure are directed to methods, systems, and/or apparatus for cooling a data center, including: utilizing a cooling tower configured for a power station, and diverting a portion of make-up water intended for the cooling tower to the data center for cooling, when the marginal benefit provided by the performance of the cooling tower in minimizing cooling water effluent temperature in minimizing backpressure within the boiler condenser to improve plant output and thus thermal efficiency is small or counterproductive, or when said cooling water flow rate and/or temperature from the cooling tower is in excess of what is required for the boiler condenser, said diverted cooling tower make-up water utilized in at least one either direct or indirect heat exchanger to cool the heat rejected by a data center, this method minimizing or eliminating the penalty to thermal performance or output of the power station. At least some embodiments further include cooling the cooling tower make-up stream in transit to the data center with an absorption chiller that is driven by steam or heated water or flue gas from the thermal power station, or utilizing cooling water chilled by the absorption chiller to augment supplement the cooling tower make-up stream, and rejecting heat either to the cooling tower, or any existing ancillary heat exchanger at the plant site in contact with a cooling water body or another thermal generating unit at the same station. At least some embodiments further include cooling the cooling tower make-up stream in transit to the data center with an absorption chiller that is driven by steam or heated water or flue gas from the thermal power station, or utilizing the cooling water chilled by the absorption chiller to supplement the cooling tower make-up stream, and rejecting heat to a condenser section or one or more additional heat exchangers following the condenser section and preceding the inlet to the steam boiler, the latter in a manner to return heat to a steam cycle to contribute to one or both of power generation and unit thermal efficiency.

At least some aspects and embodiments of this disclosure are directed to methods, systems, and/or apparatus fprof providing cooling water for a data center, that uses the boiler make-up water from a nearby thermal power station, such boiler make-up water provided by a conventional source, and diverts such make-up water either through a direct or indirect heat exchanger, to provide water that cools the data center, and is returned as make-up water to the boiler, improving boiler thermal efficiency due to the heat added by the data center. At least some embodiments further include the boiler make-up water being heated prior to the plant treatment or purification system, and by heating the water entering the treatment equipment, improving the treatment system capability in terms of the degree of reduction of trace species, or achieving a given level of trace species reduction with process chemicals, reagents or consumption of power.

At least some aspects and embodiments of this disclosure are directed to methods, systems, and/or apparatus including a combination of a data center and a power-producing plant, including: a data center that produces heat; a power-producing plant that produces heat and has a source of water; an apparatus for transferring heat from the data center to the power-producing plant by heating a portion of the source of water with heat from the data center and transferring the water after the heating back to the power-producing plant.

At least some aspects and embodiments of this disclosure are directed to methods, systems, and/or apparatus for cooling a data center, including: at least one data center; a thermal power station; a cooling water source, the source selected from at least one of: a cooling water body, a lake, a river, an ocean, or a cooling tower with effluent and inlet streams of cooling water, cooling tower blowdown, and cooling tower make-up; at least one, or at least both, a direct and an indirect heat exchanger; at least one absorption chiller; where, only over a portion of a year, the cooling water alone is utilized to cool heat rejected by the at least one data center, in conjunction with the at least one, or at least both, heat exchanger; and during other portions of the year, the absorption chiller either augments or replaces the cooling water to cool heat rejected by the at least one data center, in conjunction with the at least one or at least both heat exchanger, and where the system is configured to put the rejected heat in the cooling body or cooling tower or the boiler water after it passes through a condenser.

Other exemplary embodiments and advantages of this disclosure can be ascertained by reviewing the present disclosure and the accompanying drawing.

### BRIEF DESCRIPTION OF THE SEVERAL VIEWS OF THE DRAWING(S)

This disclosure is further described in the detailed description that follows, with reference to the drawings, in which:

FIG. 1 shows an example of a relationship describing the capital cost of generating equipment as a function of scale;

FIG. 2 shows an example of the price history of fuel oil and natural gas to one particular source of coal, based on a cost per million unit of energy ($/MBtu) as fired;

FIG. 3 is a schematic of a data center from a power consumption and cooling standpoint;

FIG. 4 shows a schematic of a conventional thermal fossil power station;

FIG. 5 shows the tradeoff in boiler condenser cooling water flow and condenser backpressure, that is determinate in operating a power plant for maximum efficiency;

FIG. 6 shows an embodiment of integrating the cooling needs of a data center with the cooling resources of a thermal power station, in this case diverting cooling water extracted for the power station to the data center in accordance with aspects of this disclosure;

FIG. 7 shows the monthly variation of the mean air temperature of several states distributed geographically across the U.S.;

FIG. 8 shows a schematic of a process flow sheet with boiler make-up water that can be utilized for cooling in accordance with aspects of this disclosure;

FIG. 9 shows an arrangement of an absorption chiller, utilizing heat from low quality steam, and a data center integrated into the process of a thermal power station in accordance with aspects of this disclosure;

FIG. 10 shows an arrangement of an absorption chiller, utilizing heat from combustion products, and a data center integrated into the process of a thermal power station in accordance with aspects of this disclosure;

FIG. 11 shows an arrangement utilizing cooling tower blowdown as cooling media for a data center in accordance with aspects of this disclosure;

FIG. 12 shows an arrangement where an absorption chiller is utilized to return waste heat from the data center to the boiler to improve thermal efficiency or power output, in accordance with aspects of this disclosure;

FIG. 13 depicts an arrangement where cooling tower blowdown from a cooling tower, as augmented by an absorption chiller, is utilized for data center cooling in accordance with aspects of this disclosure;

FIG. 14 depicts an arrangement where cooling effluent from a cooling tower, as augmented by an absorption chiller, is utilized for data center cooling in accordance with aspects of this disclosure; and

FIG. 15 shows an alternative arrangement to FIG. 13, where cooling tower blowdown from a cooling tower, as augmented by an absorption chiller, is utilized for data center cooling in accordance with aspects of this disclosure;

### DETAILED DESCRIPTION OF THE INVENTION

Exemplary embodiments of this disclosure are described herein by way of example.

This disclosure addresses configuring, implementing, and operating a data center that serves, for example, the internet and that can lower, or even completely avoid, the emissions of carbon dioxide (CO₂), and further can lower data center operating cost.

There are numerous cases in present commerce and industrial energy-consuming enterprises where lowering CO₂ emissions is counter to economic viability of operations.

The unique and innovative system, method and apparatus defined in this disclosure shows that operating a data center with low, or even zero, CO₂ emissions while incurring low operating cost is not incompatible.

CHALLENGE—There has been an enormous growth of datacenters and their commensurate use of electrical power. In the context of this disclosure, a datacenter is defined as a secure location for web-hosting servers, or as a concentration of servers and data storage hardware, ranging from several hundred to over 10,000 servers or units or even more, within one location or warehouse, that provide the transactions to power the internet. A data center is configured such that the servers and the data storage equipment housed on them can be protected from environmental hazards and security breaches. Data centers can also include not only web-hosting servers but networked storage devices that store information for enterprise computations and transactions. By some estimates, datacenters in 2006 consumed approximately 61 billion kWh of power, or approaching about 1.5% of national power consumption (IDG, 2007). The population and growth of data centers is predicted to expand, with forecasted power consumption to increase by 40% between 2005 and 2010 (Koomey, 2007). Data centers clearly utilize a significant and increasing portion of power consumption and production of CO₂.

Many owners and operators of data centers select sites that are located near the fiber optic networks that access the internet, while also attempting to lower the carbon footprint or emissions of greenhouse gases, as defined by the production of carbon dioxide CO₂. Specifically, major players in these enterprises such as Microsoft, Amazon, IBM, and numerous other operators have focused on locating data centers in the Pacific Northwest, due to the broad availability of renewable and relatively low cost hydropower in that region. Also, Microsoft recently selected San Antonio, Tex. as a site for a datacenter, citing the relatively large fraction of existing and planned renewable electrical generating capacity in Texas, in addition to other environmental attributes such as access to recycled “gray” water. Further, Fijitsu recently sited a datacenter in Santa Clara, Calif., using a fuel cell to generate power. These cases are exemplary as to the growing interest in “green” data centers. However, in most of these cases, efforts to lower the CO₂ footprint and maximize the “green” nature of the data center are not necessarily economically viable. Specifically, with regard to the Fijitsu Santa Clara site, the fuel cell was rendered a viable option only with a $500,000 support from the local utility (IDG, 2007). Although solar and wind power are attractive renewable options, such power to date is generally only economical with federal tax breaks and subsidiaries. The so-called “green” sites for data centers that also offer economic viability are in need.

Separate from the interest in green data centers is interest for configuration of a data center that can minimize capital and operating cost. Whitted (U.S. Pat. No. 7,278,273) has taught the use of modular data centers, utilizing air-based heat exchangers to remove heat, that can be configured with either or both a modular power generation equipment, or modular cooling towers. As described by Whitted the advantage of this concept is to provide a complete data center and power generation or cooling package that is easily transportable, and can be located independent of any needs for supporting power, or cooling facilities. An advantage of such transportable, modular data centers and power supply facilities can be to provide improved flexibility in locating or siting data centers. However, there can be strong cost and performance disincentives to utilize a modular power generator, or cooling tower. This approach will likely provide greater flexibility to the owner or operator of a data center in selecting a location.

It is instructive at this point to distinguish between a large, centrally located thermal power station, and a system assembled from small, modular, transportable power generation components. The large, central thermal power station is configured for a particular site, type of fuel, and heat rejection means. The configuration, although perhaps based on a reference plant case, can be customized and optimized for the site. In particular, the cooling system can generally be optimized for the availability of local cooling resources, either a cooling lake, river, or ocean; or adequate space and access for cooling towers. These thermal power generation units can be fired by any fuel, fossil such as oil, gas, or coal; or nuclear. Given the importance of operating cost to data center feasibility, coal-fired thermal power stations are of particular interest, due to access to the lowest power production cost. The large physical size of these units can allow significant investment in acquiring optimal cooling resources, such as withdrawing water for cooling from a lake at regions known as the lowest temperature source.

The utilization of small, modular components to assemble a power station dedicated to serve a data center can provide different cost and performance characteristics. Specifically, the concept of generating capacity scale or size can be key, as the power generation process can be a notoriously capital-intensive operation, with both capital and operating cost strongly dependent on economies of scale. Further, the use of modular systems can all but preclude the use of any solid fuels, such as coal, as coal-fired power stations are almost exclusively custom, site-specific designs tailored for the fuel and location. Further, these systems are not available in small, modular-type components, as the steam boiler, steam turbine, and coal handling systems are not amendable to packaged designs that can be easily assembled on-site.

Regarding cost, the capital cost of process equipment and operations can decrease significantly, per unit of generating capacity, with increasing size or scale. The incentive to exploit the size or scale of generating equipment is a basic premise of utility industry operation.

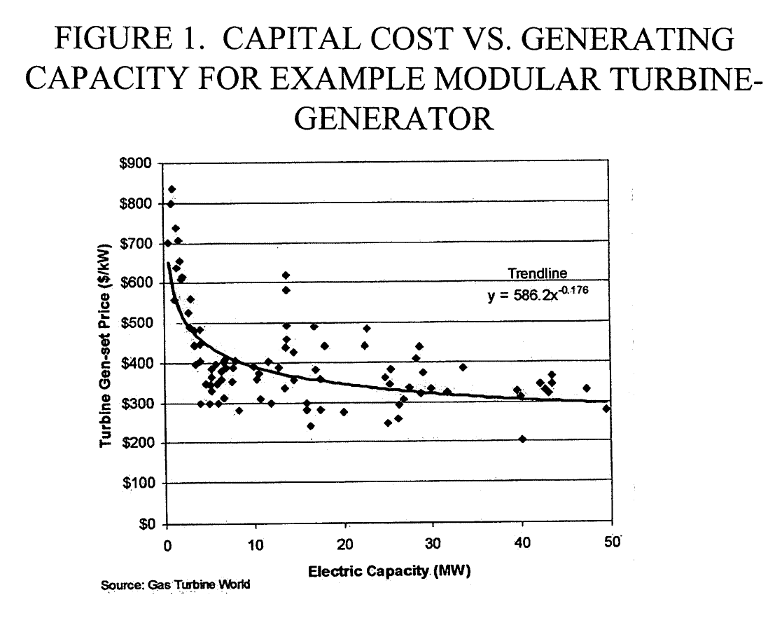

FIG. 1 presents an example of a relationship describing the capital cost of generating equipment as a function of scale, for small generating systems that are of the same size as modular components discussed by Whitted. This relationship was published in a literature review by the U.S. Department of Energy of alternative generating options, of the type that would be considered modular generating options (DOE, 2002). The capital cost shown in FIG. 1 does not represent a complete scope of equipment, so actual installed costs for generating equipment will be considerably higher. However, the trend to lower capital cost with higher generating capacity is expected to be similar. The capital cost shown is for one specific type of generator, showing the advantage of exploiting the larger size of a central thermal power station to achieve lower costs. There will be cases where the modular approach as described by Whitted to both power generation and the construction of the data center can be advantageous, for example by locating a generator near a source of low cost fuels such as byproduct “digestor” gas from landfill, or a byproduct liquid petroleum-derived fuel from refining operations. However, these cases can be rare. In general, FIG. 1 shows that for any given demand in power consumption, providing such power with modular, easily transportable systems can require relatively high capital cost, per unit generating capacity ($/kW), leading to relatively high cost power.

Regarding fuel type, almost without exception, the small, modular power generating systems can only utilize fuels that are relatively clean, without inorganic materials such as sulfur or ash. This can be because the necessary environmental controls to process fuels with the content of ash, sulfur, and other constituents are not available in small, modular sizes, while providing the control efficiency or effectiveness necessary. Accordingly, the modular systems can be confined mostly to using fuels such as fuel oil and natural gas. Given the relatively high cost of fuel oil and natural gas compared to solid fuels or coals, the modular power systems necessarily must generate power at higher cost. Thus, the modular systems as proposed by Whitted, can incur higher capital cost, and can also primarily utilize clean or premium fuels.

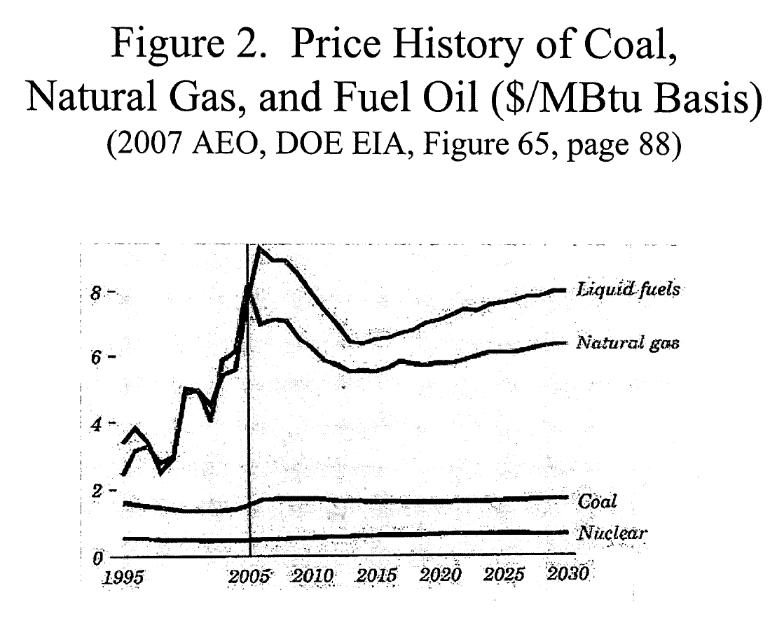

FIG. 2 depicts an example of the price history of fuel oil and natural gas to one particular source of coal, based on a cost per million unit of energy ($/MBtu) as fired, as extracted from the Department of Energy's Energy Information Agency Annual Energy Outlook (2007). Thus, for both capital cost and fuel cost, the advantage of a large, centrally located thermal power station in terms of incurring lower capital cost and lower fuel cost can result in a cost advantage in generating power. Accordingly, central thermal power stations can offer an advantage as a host site into which to integrate the operations of a data center.

Finally, planning the configuration of a data center around the scale and architecture of modular components, although deriving flexibility in site location, can constrain the equipment selection and performance. Specifically, the use of modular, necessarily smaller cooling towers configured for industrial purposes (e.g. not utility-scale power stations) can not always provide the same efficiency in rejecting heat as a large, mechanical or forced draft cooling tower configured for a power station.

For example, a modular system can frequently be required to utilize a “short” tower, to retain a low profile depending on the industrial setting and local architectural demands. Cooling towers that are short and require a low profile can frequently use centrifugal fans, which consume significantly more power than a conventional (e.g. taller) cooling tower and an axial fan, for example, compared to a cooling tower whose design is unconstrained (“Code Change Proposal for Cooling Towers”, Codes and Standards Enhancement Report, for 2005 Title 24 Buildings Energy Efficiency Standard Update, prepared by PG&E, Apr. 8, 2002).

Accordingly, there can be thermal performance benefits to exploiting the configuration of a cooling tower sized for a power station compared to a smaller, dedicated, stand-alone device.

The concept of integrating the cooling needs of a data center with the cooling resources of a power station has not been recognized before. Both the data center method described by Whitted and a document prepared by the Department of Energy (DOE) and issued as a Tech Brief (DOE Tech Brief, Thermally-Activated Absorption Chillers, Distributed Energy Technologies, published by the Department of Energy, Office of Energy Efficiency and Renewable Energy) addressing the cooling of data centers cite that such facilities can use waste heat from a boiler or a combined heat and power (CHP) system, as the thermal energy source for an absorption chiller. In addition, the August 2007 “Environmental Protection Agency Report to Congress on Server and Data Center Efficiency; Public law 109-431” describes the use of CHP systems where data centers are located. However, these sources do not specify the further integration of the data center with the thermal power station. Specifically, the DOE Tech Brief states waste heat sources are ideal, but limits the application to commercial buildings with access to steam, industrial processes, and commercial buildings with natural gas availability, and government buildings.

The EPA Report to Congress contains an entire passage (Section 6.2.3.) on CHP, and presents a summary table identifying where on-site power systems are located where data centers exist—but does not address the inverse option. Specifically, Table 6-6 of the EPA report identifies examples where on-site power is used with data centers, but all of the referenced on-site power generating equipment employ the small, modular, and relatively high generating cost systems described earlier by DOE (DOE, 2002). The recommended practices stop at that point—there is no acknowledgment that further integrating the process with a thermal power station using waste heat and station cooling facilities, or that returning the heat rejected by the data center back to the boiler as a way to further lower operating cost. There is also no recognition that the utilization of low quality steam, even that designated as “waste steam”, for cooling can increase CO₂ emissions, as this steam when condensed and reheated can require under some conditions more fuel to reheat in the steam boiler. This low quality steam can provide CO₂-free work, if it is at a pressure and temperature that would normally condense in the boiler condenser without delivering heat to the thermodynamic cycle. With the CO₂ implications of waste heat utilization in mind, this disclosure teaches methods to provide for truly waste heat as a source for an absorption chiller with negligible CO₂ increase.

DATA CENTER ENERGY FINGERPRINT—A help to understanding the unique aspects of the innovation that is disclosed in this disclosure is the characteristics of data center power and cooling needs, and the attributes of a thermal power station. Within each lie synergies that can be exploited to provide a “green”, economically viable data center.

The power consumption and cooling characteristics of data centers have been well-documented. The power consumed for cooling the computing environment approaches the power that is consumed by the servers (Tschudi, W. et. al., “High Performance Data Centers: A Research Roadmap”, Lawrence Berkeley National Laboratory, Berkeley, Calif., LBNL-53483). Specifically, power consumed by the microprocessors and ancillary components is converted to heat, which accumulates within the confines of the data center and must be removed. Server components other than microprocessors that generate heat are memory, hard-drives, and ancillary circuitry. Most of the key elements of a data center serve the purpose of removing heat generated as a waste product—the cooling fans, and the heating, ventilating, and air conditioning (HVAC) systems, including air delivery throughout the data center. The need for lighting and other ancillary services completes the energy demand. Although the layout and architectural concepts for data centers are constantly evolving, power consumption characteristics to date have for the large part been invariant.

In terms of a basic energy balance, providing electrical power for the cooling or removal of waste heat represents extremely poor utilization of fossil fuel—and unnecessary production of CO₂. The poor utilization of fossil fuel is evident when considering from a thermodynamic standpoint the counterproductive nature of how power is consumed, and then must be removed, from a data center. For example, fossil fuel used to generate power in a conventional power station may do so at nominally 35% thermal efficiency, and almost all power that is consumed by the servers is introduced into the datacenter environment as waste heat. The usual method of cooling—a conventional compression vapor HVAC system driven by electric power—will remove such heat at a coefficient of performance (COP) that over a wide range of operation may vary between 1 and 4, for example. Even at a COP of 3, the sequence of process steps demonstrates the inefficiency of operating these processes together. Specifically, consider the (a) generation of power for the servers at 35%; (b) conversion of this power to heat as a byproduct of operating the servers; and (c) conversion of fossil fuel to electrical power to drive the compressor and remove heat at COP of 3. Consequently, for every Btu of fuel fired to drive a server, an additional Btu of fuel is necessary to remove the residual heat at a COP of 3; an additional 1.5 Btu are needed at a COP of 2. The illogic of these steps in sequence is compelling: an electric-driven compressor to operate an electric-driven HVAC system, to remove waste heat generated by an electric-driven microprocessor. It is no wonder why power supply dominates the operating cost of datacenters, and the CO₂ footprint is unattractive.

Next generation data center concepts are evolving to address this problem. Most significantly, the use of direct cooling by means other than electric-driven conventional HVAC systems is being explored, in some cases directly utilizing what is referred to as chilled water (e.g. 40° F. to 50° F., for most conventional applications) as a cooling media in a closed cycle. Although the use of so-called “chilled” water at 40° F.-50° F. is the historical approach, new packaged or modular systems are presently being built to operate at higher temperatures, such as approximately 65° F. Examples of such a system are the Rackable Systems Ice-Cube modular data center, and the Sun Microsystems Blackbox. In order for these modular systems to be economically competitive, the sources of chilled water or cooling water must not consume significant amounts of power and thus fossil fuel. That is, if either the chilled or cooling water is not generated with low fuel or low carbon implications, then operating costs may not be reduced, and the improvement in terms of lowering the carbon footprint will be modest or perhaps illusory.

The amount of cooling water that is necessary depends on the design of the heat exchangers within the packaged or mobile data center modules, and the number of modules. The specific flow rates will vary with the individual design of each. However, as an example, consider a data center module with 1100 servers, each consuming about 335 watts of power. The total power demand for this module will be approximately 0.34 MW of power. If 85% of the power consumed by the operation of these servers is transformed into heat that is captured by a heat exchanger, then the flow rate of cooling water required will be related to the temperature differential. Specifically, if cooling water at 65° F. is available and is returned from the heat exchangers at 80° F., then approximately 140 gpm of cooling water is required. This translates into a cooling water flowrate of 425 gpm per MW of electrical consumption.

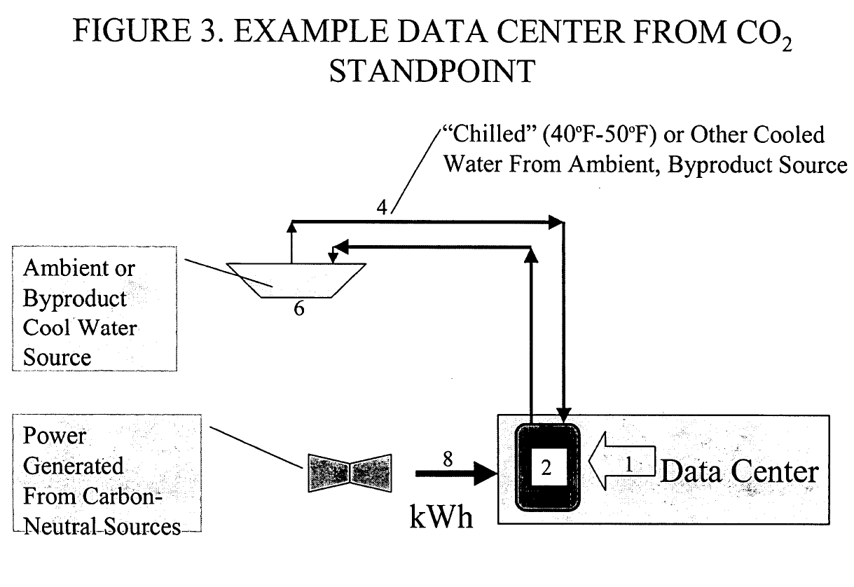

FIG. 3 represents a schematic of a data center that from a power consumption and cooling standpoint can be ideal. Specifically, waste heat 1 generated is removed by heat exchanger 2 and cooling media 4, such as water, which is provided to the data center with no carbon implications. This source may be a natural ambient body 6, or alternatively an industrial process byproduct. Further, the power 8 for server operations is from renewable sources, or other forms of power generation such as nuclear generation or biomass that do not produce CO₂. For FIG. 3 to be achieved in practice, the cooled or chilled water can be derived from the ambient environment (6), or as a waste byproduct, and renewable or carbon-neutral sources of power are necessary. In order for the concept in FIG. 3 to be viable economically, these conditions must be commercially achievable with high reliability, on essentially a 24×7 basis, throughout the entirety of the year. The sources of power and candidate data center sites to accomplish this goal, using conventional practice in siting and configuring datacenters, can be limited.

FOSSIL POWER STATION—At least some attributes for the FIG. 3 datacenter can be provided by exploiting the operating conditions and equipment of a thermal power station. In the context of this discussion, a thermal power station can absorb heat from a fuel or other source, such as nuclear fuel, and rejects heat into the environment, utilizing some form of ambient air or water for cooling, either directly or through a vehicle such as a wet or dry cooling tower, or once-through cooling equipment. Many of the needs depicted by FIG. 3 can be accomplished by further integrating the cooling needs of the data center with the available cooling resources of the thermal power station. This can be enabled by co-hosting the data center within the confines of, or adjacent to, the thermal power station, to integrate the needs of both enterprises. As will be shown, a central thermal power plant can provide several attributes that can be exploited to lower both carbon emissions and operating cost.

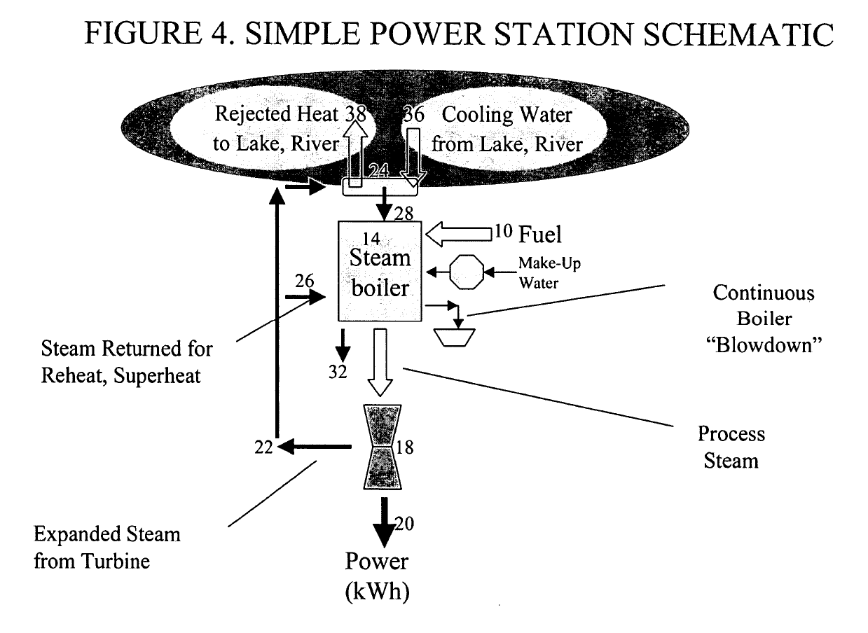

FIG. 4 presents a schematic of a conventional thermal fossil power station, equipped with a steam boiler and steam turbine for production of power. Fuel 10 is fired to generate steam in a boiler 14, which is delivered to a steam turbine 18 to create first shaft work, and then electrical power 20 from a generator. Typical of present technology steam turbines, the steam after expansion by the turbine 22 is directed to a condenser 24, and is collected as condensed liquid, although a portion of the steam before condensation can be returned to the boiler for reheat or superheat 26. The condensed steam, referred to as condensate, usually exits the condenser at a temperature range of 95° F. to 102° F., and is directed to a boiler feedwater heater (not shown), and subsequently returned as condensate stream 28 to the boiler 14. At this point the process is repeated. The example in FIG. 4 depicts a thermal power station cooled by so-called once-through cooling, in which the condenser is cooled with water 36 from a river, lake, or ocean, and returned 38 to the same body but at a different, downstream location. In the absence of such a cooling body, a cooling tower (not shown) can be utilized. To maximize the removal of heat from the condenser and thus plant thermal efficiency, operators usually strive to use as much cooling water, and as low a temperature, as allowed by the water use permit or the design of the cooling system. When utilized, cooling towers can be operated to provide low temperature water.

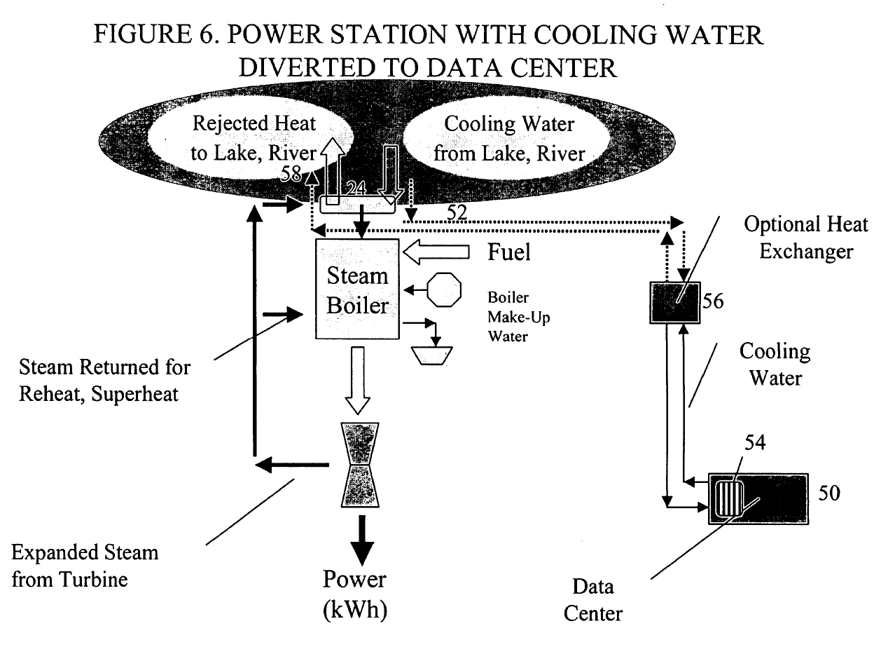

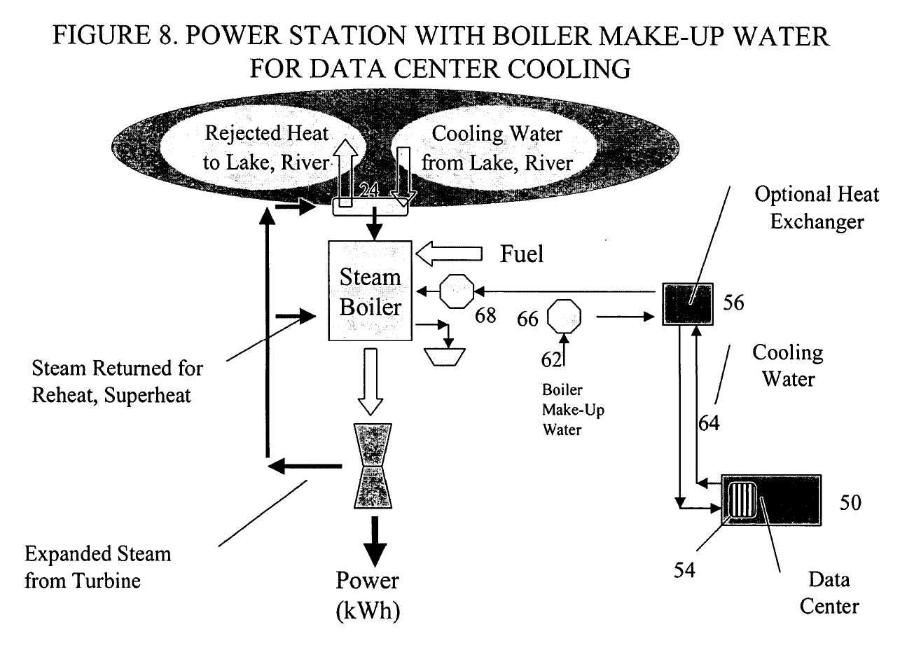

In order to recognize the innovativeness of the embodiments described in this disclosure, it is helpful to understand how the conditions of steam change through this cycle. The following example addresses a steam-derived Rankine cycle, but does not restrict the application described herein to such a generating unit; the concept equally applies to a Brayton cycle, a combined Rankine-Brayton cycle, or even a nuclear-fueled power station. As shown in FIG. 4, steam leaving the boiler can be generally “superheated”, meaning delivered at elevated pressure and temperature. Expanding steam through the turbine 18 reduces the pressure and temperature significantly, so that there is only a small amount of useful energy, or enthalpy, remaining. Portions of the steam media can be returned 26 to the boiler, for the purpose of reheating or superheating, for expansion again in the turbine, while the remaining flow is directed to the condenser 24, and ultimately the feedwater heater. A detailed flow schematic of the steam cycle is described in several of the classic boiler texts, such as “Steam” (See FIG. 8 (page 2-15) and FIG. 2-10 (page 2-19) of Steam, 40^{th} Edition, published by the Babcock & Wilcox Company, 1992, Library of Congress Catalogue # 92-74123 ISBN 0-9634570-0-4) and “Combustion” (See FIG. 6 (page 1-7) and FIG. 8 (page 1-10), of “Combustion”, edited by Joseph Singer, Fourth Edition, published by Combustion Engineering, 1991, Library of Congress number 91-9605974-0-9). It should be noted that after expansion in the turbine 18, steam exists in a state that can provide marginal value in terms of power production, but can still be useful where high enthalpy is not required. Within the plant, common uses for such low enthalpy steam 32 can be as a media in steam-driven “sootblowers” for cleaning furnace walls, or cleaning environmental components such as catalysts. In addition, some types of forced draft or induced draft fans that move combustion gases through the boiler can be driven by steam, instead of consuming auxiliary power. A benefit of the latter can be that overall thermal plant efficiency can be improved, as the low quality steam can be utilized for useful work, allowing valuable power to be conserved.

Thus, with regard to a data center, an attribute that a thermal power plant can provide is available steam that has been expanded in the turbine and that, although low in enthalpy and of reduced value for generating power, can still provide a useful function, such as driving a compressor at small cost, or providing auxiliary heat for cleaning, or cooling.

Another attribute of a fossil plant that can match the needs of a data center is access to an effective sink for heat rejection. A thermal plant, as a heat engine abiding by the general principles of the Carnot cycle, operates at a thermal efficiency that depends (among other factors) on the temperature at which waste heat is rejected. Thus, plant operators strive to find a very low temperature at which to reject waste heat. For this purpose, thermal plants generally utilize rivers, natural lakes, or man-made lakes or cooling ponds to accept rejected heat. More specifically, most power stations seek cooling not from surface waters but subsurface waters, which are accessed from below the surface and thus generally are of lower temperature than the surface water. Some power stations, in an effort to access the lowest temperature water, employ intake structures that extract water from the bottom of a lake, well offshore. The condenser 24 depicted in FIG. 4 is the primary vehicle for transferring this heat to the environment. If natural cooling water from these sources 36 is not available, then either mechanical draft or natural draft cooling towers can be utilized. The amount of cooling water utilized by a thermal power station can vary with the specific plant and configuration of the cooling condenser. In general, a once-through cooling system can utilize about 600-700 gpm per MW of capacity.

There can be a legal or regulatory constraint to the amount of heat that a power plant can reject into a receiving water body, or other environment. Depending on the local regulatory agencies that issue thermal discharge permits, an operating limit can exist defining the maximum amount of heat that can be rejected into a receiving body 38. Specifically, most thermal discharge permits limit either the temperature rise of the receiving water body, or the maximum temperature to which a receiving body of water can be elevated, attributable to the operation of a thermal power station. At times the power plant load or generating capacity, particularly in summer months and for units located in southern and warmer climates, can be limited by the maximum thermal discharge limit. A further consideration is that the temperature of the receiving body—be it the lake, river, ocean, or man-made body—will vary throughout the course of the year; accordingly heat-derived limits on operation may only exist, or be more frequent, in the summer than other periods of the year. Regardless of these constraints, the cooling system dedicated to a thermal power station can be exploited to contribute to directly cool a data center. Specifically, although it can be important to maximize the removal of heat from the condenser for many periods during the year, particularly in winter, the thermal performance of the plant is driven by conditions within or on the surface of the condenser, and either an additional quantity or lower temperature of cooling water may not necessarily contribute to improving thermal plant performance. Accordingly, cooling the condensers by either a body of water or cooling towers may not require the maximum amount of cooling capability available or permitted. For these conditions, excess cooling capability may be available that cannot be utilized by the thermal plant. This capability thus can be used for cooling data centers.

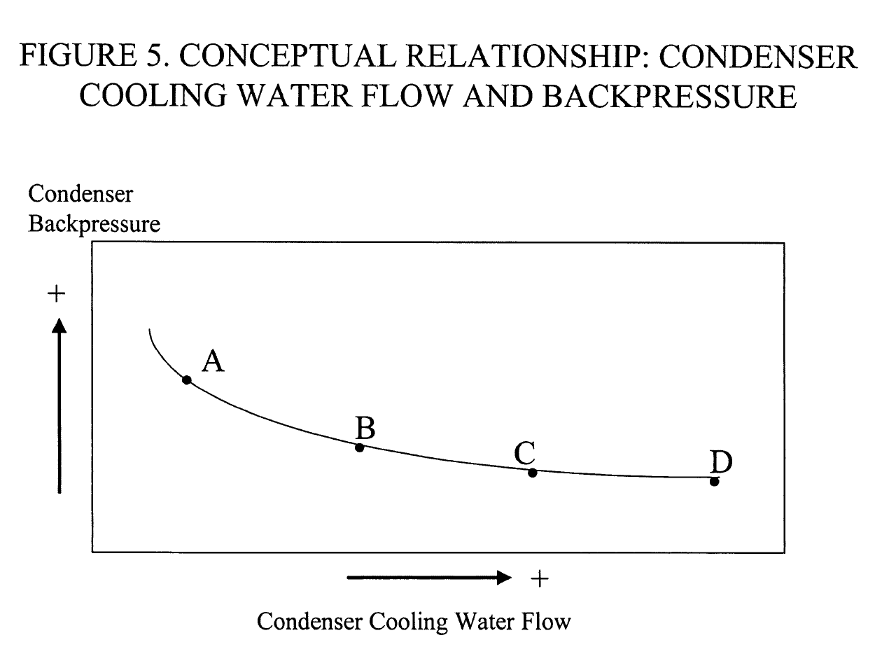

The tradeoff in operating a power plant and specifically the condenser for maximum efficiency and the water flow required is depicted by FIG. 5. This figure shows the general relationship between the absolute pressure in the boiler steam condenser and the volume of cooling water that passes across or through the condenser. The source of the cooling water is not important, and can be either the flow from a cooling water body, or the effluent from a cooling tower. Achieving a lower static pressure within the condenser can be desirable to improve plant heat rate. FIG. 5 describes the general relationship between cooling water flow rate and condenser static pressure for a given thermal power station cooling system, depending on configuration and whether the unit is operating at part or full load. FIG. 5 is for illustrative purposes only, and depicts only the general relationship; the specific details at any site for any one design boiler, condenser, and cooling water source and system will vary considerably. FIG. 5 represents a typical non-linear relationship, where increasing amounts of cooling water provide a benefit in lowering condenser static pressure. However, at some point successive increases in water flow provide a smaller, marginal additional benefit. Specifically, the benefit in terms of decreasing or lowering static pressure within the condenser when water flow increases from A to B is significant. However, increasing the water flow from points C to D provides only marginal benefit. In actual operations, the cooling system may consume more auxiliary power to provide the higher flow rate of cooling water than the increase in power generated or thermal efficiency delivered through improved condenser performance. At these conditions, it may be to the benefit of the plant operator to not maximize water flow at point C or D, but instead operate the condenser at point B. At these conditions the cooling system is not operating at full capacity, and some of the cooling water can be diverted to other uses, such as providing cooling capacity for an on-site operation such as a data center.

Another attribute of a thermal power station that can be exploited by a data center is the ability to utilize the byproduct heat generated by the servers, to augment power plant thermal efficiency. As depicted in the referenced schematics in the referenced texts of “Steam” and “Combustion”, there are several locations where heat can be introduced into the thermodynamic cycle, to derive an increase in boiler thermal efficiency or power production. The most frequently utilized, although not the only, equipment for this purpose is the boiler feedwater heater. Referring to FIG. 4, a boiler feedwater heater (not shown) can be located between the condenser 24 and boiler 14, through which the condensate 28 passes. The boiler feedwater heater can serve to pre-heat water from the condenser returning to the boiler, after most useful work has been extracted. As will be shown subsequently, preceding the boiler feedwater heater are several supplementary heat exchangers that cool the steam turbine lubricating oil and hydrogen coolant, which also represents a zone where waste heat from an external source could be transferred to condensate. Yet another way for the thermal power station boiler to utilize waste heat is to preheat boiler make-up water that is added to replace that water discharged or “blown-down” to purge the boiler of undesirable constituents, which may interfere with operation or induce corrosion.

There are many ways in which waste heat from an industrial process can be transferred to a steam boiler or thermal power station, not all of which are identified in this document, that serve to improve thermal plant efficiency or generation. It should be noted this concept of utilizing waste heat from a commercial or industrial source to improve the thermal performance of a power station boiler is the inverse of the usual thinking in utilizing waste heat. Specifically, it is usually the power station waste heat that is directed to a commercial or industrial process; this case is the opposite.

In summary, it is these attributes of any type of thermal power stations—the availability of low grade, low quality but still energy-containing steam and waste heat from combustion products, a ready source of cooling media which at some times may exceed what can be effectively utilized by the thermal power station, and the opportunity to convert waste heat from any source into power—that presents a unique opportunity to reduce the operating costs and carbon footprint of a data center.

The needs of the two enterprises of effective thermal plant operation and cost and fuel efficient data center operation can be simultaneously provided for by utilizing several process steps that feature heat exchangers, and an absorption chiller.

INTEGRATING THE DATA CENTER AND POWER STATION—FIG. 6 presents the first of several schematics depicting a data center where the cooling needs are integrated with the cooling resources of a thermal power station, which in this case is co-located at the thermal power station. The background information described will be used to show how the needs for a low CO₂, or even a zero CO₂, data center can be met by integrating the cooling needs and resources of the data center and the power station, enabled in this case by co-locating the data center at a thermal power station. The thermal power station can be any unit described by a Carnot-determined efficiency, such as a fossil-fuel fired boiler and steam turbine, a combustion turbine, or even a nuclear-fuel thermal power station. Geothermal facilities can also offer some of the same opportunities.

The data center in FIG. 6 is based on the same concept as depicted in FIG. 3, and employs cooling water to reduce the temperature of air utilized to cool the servers of a data center 50. Any suitable method by which the cooling water (52) is utilized within the data center 50, and the inlet and outlet temperatures of this cooling water, can be utilized with the embodiments of this disclosure. For example, the cooling water 52 can be utilized directly in a heat exchanger 54 that is close-coupled to a plenum into which cooling air from the servers is aspirated, or other means of conveying heat from the server racks, and the temperature of the water can be of any value to provide necessary cooling. Co-locating the data center at a power station can provide the opportunity to access the cooling water at a negligible cost, and negligible carbon footprint. Two sources of cooling water exist: (a) utilizing the plant cooling media in any of various forms, either directly or with an indirect heat exchanger, and (b) using an absorption chiller to deliver heat from the data center to the boiler working fluid, again either directly or with an indirect heat exchanger. Each of these is described below.

Direct Utilization of Power Plant Cooling Media—A straightforward approach to integrating the thermal functions of a datacenter and a thermal power station is to provide the data center cooling water from the medium devoted to cool the thermal power station, such as a river, natural lake, made-made lake, or ocean. Alternatively, if a cooling tower is used for data center cooling, any of several streams either to or from the cooling tower can be used for data center cooling. FIG. 6 shows water extracted from the cooling body 52 that is directed to the data center. In order to lower the carbon production attributable to data center cooling, water extracted for data center cooling should not compromise thermal power station performance. Thus, even if the thermal power station is not operating at maximum generating capacity, directing cooling media away from the steam condensers 24 to service the data center can, under some circumstances, compromise plant thermal efficiency and heat rate; any savings in energy by the data center will be partially or completely offset by the compromise in thermal efficiency of the thermal power station. However, for cases where heat rejection by the steam condensers is limited not by the quantity of cooling water but the heat transfer coefficient or other heat transfer phenomena within the steam side or the cooling water side of the condenser, thermal power station cooling water can be directed to the data center without heat rate or boiler thermal efficiency impact. Depending on the details of the power station water use permit or the thermal discharge permit, or the point of location of cooling water extraction, a sufficient quantity of thermal plant cooling water could be available for data center cooling. Or, depending on the amount of water required for cooling, the extraction rate of cooling water to service the data center is insignificant in the context of power station heat rate. As an example, and not to provide any limit in use or application, the diversion of less than 2 to 3 percent of the cooling water allowed by permit will probably impart a heat rate effect less than any reasonable measurement accuracy, and on the order of other uncontrolled variables affecting condenser performance, and thus may be of little if any consequence. This cooling water from the river, lake, or ocean can either be used directly in the heat exchangers that are located within the datacenter 54, or in an indirect heat exchanger 56 that lowers the temperature of a closed cycle of a separate cooling media to provide data center cooling. In order to not impact plant thermal efficiency, the heated water can be returned to a location 58 that does not impair the performance of cooling the steam condenser. It should be noted most power plant intake water structures can accommodate this arrangement—water can be extracted remote from the shoreline and near the bottom of a lake or river, and heat-containing water returned at a location removed from the intake.

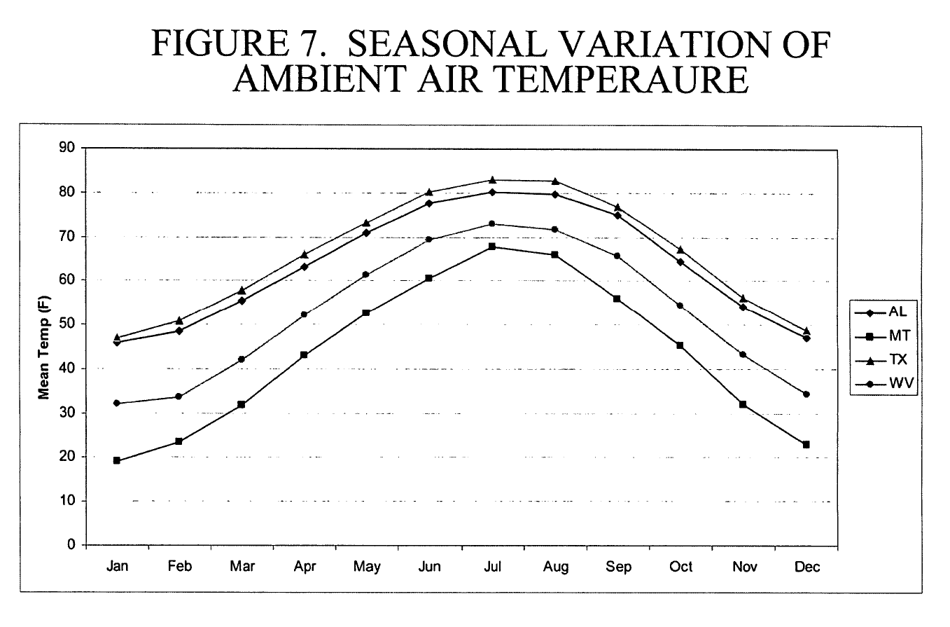

If feasible, for certain locations, this opportunity may only exist during portions of the year, such as in winter, or when the plant does not operate at maximum capacity, and there is margin in both the thermal discharge and water use limits allotted to the plant. Thus, one possible cooling scheme would be to utilize water directly from the river, lake, ocean water, or other source, when the temperature allows providing the necessary cooling. This will most likely be in winter months, extending to spring and fall in some locations. As an example of the type of variations in temperature that can be encountered, FIG. 7 presents the monthly average of ambient air mean temperature for several states throughout the course of the year. This relationship can be important as the temperature of any surface water will in many cases be relatively close to and track that of ambient temperature. Also, the ambient temperature can be related to the wet bulb temperature, which as will be discussed subsequently can be utilized to determine the performance of cooling towers. FIG. 7 shows that for Montana the monthly mean average is close to providing cooling water of adequate temperature on a year-round basis. Of course, the monthly mean average as shown in FIG. 7 does not describe the hour-by-hour variations that will exceed this mean and prohibit cooling. FIG. 7 suggests that depending on the temperature, the existing intake and cooling water structure can be utilized to service the cooling needs of the data center. Thermal power stations that extract cooling water from near the bottom of a lake, river, or other cooling body will be particularly advantaged, as such waters will be lower in temperature than surface waters. Particularly at low load, an excess of cooling water can exist during these months that can be directed to the data center without compromise to gross plant heat rate or thermal efficiency.

There may be times when this source of cooling water is not available at negligible plant impact—perhaps at full-load during certain months, or in the warmer periods of the year when the host thermal plant needs the cooling media to maximize thermal efficiency. Under these conditions, a separate wet mechanical cooling tower, either dedicated solely to the data center, or as a “helper” tower for the station, to augment the cooling needs of the station, can be used for portions of the year that the thermal power station cooling cannot provide the necessary heat removal duty. Several other methods to provide a low cost alternative exist, such as the absorption chiller, for which a schematic of the equipment arrangement will be subsequently presented.

At power stations where cooling towers are utilized instead of once-through cooling from a water source, the cooling media generated by the mechanical or natural draft cooling tower dedicated to the thermal power station can be utilized for data center cooling. The opportunities and constraints are similar to these for direct cooling media. Specifically, water leaving the cooling tower that is intended for the thermal power station or is being discharged as blowdown can be directed for data center cooling; usually this cooling water temperature is about a 5° F. to 10° F. approach to the wet-bulb temperature at the time. This cooling water produced by the cooling tower is generally higher in temperature than obtained from an ambient body such as a river or lake; accordingly the opportunity to apply this cooling media directly may be more limited in the course of the year. There are several sources of water associated with the cooling tower that can be utilized: the cooled effluent leaving the cooling tower and directed to the boiler, and the “blowdown” or purged effluent at the same temperature as the cooled effluent but that is directed to a discharge pond or holding basin. Both sources of water can be used, however diverting cooled effluent from the cooling tower may under some conditions compromise the thermal performance of the thermal power plant, and thus increase CO₂ production. Using the cooling tower blowdown for cooling the data center heat exchangers essentially employs a waste stream that usually is discharged to provide data center cooling without compromising thermal performance of the plant. The quantity of blowdown to purge the solids will range from about 0.75 gpm per MW at 10 cycles of concentration, increasing to 7.3 gpm per MW at 12 cycles of concentration.

The synergies between the use of cooling tower blowdown and the heat transfer characteristics of data center heat exchangers should be noted. Specifically, the most common water soluble compounds in cooling tower effluent which are controlled by blowdown are calcium carbonate, calcium sulfate, calcium phosphate, silica, and calcium/magnesium silicates. These compounds generally exhibit an inverse solubility with temperature—that is, the compounds are less soluble at higher temperature. The surface temperatures within a condenser from which heat is removed by a cooling tower effluent can be 115° F.-120° F., with local temperatures at times higher. Thus, the blowdown rate is usually established by the conditions at the surface of the boiler condenser. However, heat exchangers that present lower surface temperatures will be less prone to scaling; accordingly blowdown streams that can induce scaling in the condenser will not present scaling potential on heat exchangers with lower surface temperature. In most cases cooling tower blowdown can be used for data center heat exchanger without concern for scaling.

Finally, the amount of water required to make-up or replenish that in a cooling tower depends on the specific design of the plant, the host site, the details of water chemistry within the cooling tower, and the desired performance. This make-up water could be utilized for data center cooling, but could compromise plant thermal efficiency. Specifically, the quantity of make-up water to the cooling tower to compensate for both evaporative losses and blowdown to purge solids will be from about 8.4 gpm per MW for cooling towers operated at 10 cycles of concentration, up to 15 gpm per MW for cooling towers operated at 2 cycles of concentration. Generally, this water is accessed from well sources or lakes, and would be related to the ambient air temperature, and the point of water extraction.

A flow schematic depicting the several ways in which cooling tower effluent can be utilized is presented subsequently.

Pre-Heating Boiler Make-up Water-Another method of exploiting on-site cooling can be to utilize the boiler make-up water for cooling the data center. This option can actually improving boiler thermal efficiency, as heat delivered from the datacenter is returned to the boiler for steam generation.

As background, steam boilers can utilize the continuous “blowdown” of water, which is tainted by continued evaporation and condensation, from the steam drum requiring purging of the circulating water of accumulated solids and chemicals, such as chlorine-containing compounds. A small amount of water is usually continuously added to make-up losses from this blowdown, as well as any leaks in the system. The continual vaporization and condensation of water can concentrate impurities such as dissolved solids, chlorides, or alkaline compounds within the water cycle. If unchecked, these impurities can concentrate to many times their inlet or original concentration, and lead to fouling or corrosion of internal heat transfer surfaces, or other means of interfering with the task of heat transfer. Consequently, a small amount of water can be continuously purged or “blowdown”, to remove the undesirable solids. This purge stream is usually extracted from the bottom of the steam drum. The quantity of the purge stream can vary considerably with boiler design and water chemistry, but generally can be 1% of the total steam circulated through the boiler. Consequently, a 500 MW unit will require about 100 gpm of make-up. A consequence of discharging this water can be the discharging of the latent heat associated with the water. A heat exchanger can sometimes be utilized to reheat the incoming or treated water.

The boiler make-up water can have been exposed to a series of process steps intended to eliminate any impurities that would concentrate. The temperature of this water, which is usually obtained from local wells, can generally be representative of conditions in the local area. These water treatment steps will aerate water, or process the water by reverse osmosis (RO) or any of several other methods, such as conditioning with various compounds. Consequently, the temperature of the water after processing for make-up can be from 45° F. to 70° F., for example. Water of this temperature can be utilized as direct or indirect cooling of a data center. More importantly, the act of the data center to pre-heat the make-up water can increase the plant efficiency, by directing the waste heat into useful work. The actual heat transferred to the make-up water is less than that originally fired or processed to raise steam and generate power—but the return of some fraction to the steam cycle can improve power station performance. The pre-heated water can also improve the performance of most water treatment processes.

FIG. 8 presents a schematic of a process flow sheet with boiler make-up water that can be utilized for cooling. Boiler make-up water 62 (optionally after treatment by RO or other means) and prior to introduction into the boiler can be utilized in a closed cycle heat exchanger 56, that provides for cooling of data center coolant 64. In this embodiment, the purified water can contact only the internal surfaces of the indirect heat exchanger 56, and does not directly contact the datacenter heat exchanger 54. In this case, the actual heat removed from the data center can be limited by the effectiveness of the indirect heat exchanger that processes both data center cooling water and boiler make-up water. This embodiment can be appropriate for cases where make-up water processed by the treatment plant is of sufficient quantity and is consistently low enough in temperature to provide adequate data center cooling.

Another embodiment exists where make-up water either direct or from a water treatment facility 66 can be directed to the data center heat exchanger 54. The only barrier to utilizing this approach is that contact of the ultra-pure processed boiler water by the internal surfaces of the data center heat exchanger could re-introduce metals and oxygen that were removed in the purification step. Given the short residence time of this processed water within the heat exchanger, and the relatively clean and benign environment of the data center heat exchanger, any re-introduction of impurities is unlikely, and this embodiment can represent a viable method to effectively heat boiler make-up water and simultaneously cool the data center.

The innovative and appealing aspect of theses schemes is the recognition of data center waste heat not as a burden or byproduct to be disposed, but as a method to increase the useful work from a thermal power station. The specific benefits can depend on the steam cycle, but an increase in thermal efficiency of several tenths of a percentage point is realistic, and for a large power station, significant in terms of CO₂ emissions avoided.

Another embodiment can be to locate some or all of the boiler make-up water treatment functions in a location following the heat exchangers 56, so that a water treatment facility 68 can process boiler make-up water at higher temperature. The higher temperatures can improve the degree of de-aeration, purification, the effectiveness of lime-soda softening, or removal of trace elements from the boiler make-up water, or attain the same level of purification and trace element removal, with lower chemical costs, or both. For example, the boiler water treatment can be the hot-process phosphate method employing steam to heat the water to be treated; the heating element of this step can be reduced or eliminated. Other treatment steps such as zeolite softening or demineralization could be improved by providing heated make-up water.

The following example is presented to show how this system could be utilized. Specifically, consider that a 500 MW unit will generate about 4,000,000 lbs of steam per hour, of which anywhere from 0.5-3% is continuously subjected to “blowdown” and require make-up. Even with the use of a recuperative heat exchanger, for an average blowdown rate of 2%, the quantity of water blowdown is approximately 78,000 lbs/hr, or about 170 gal/minute. This volume of water flow is available to provide for data center cooling for at least one module containing approximately 1100 units. It should be noted this boiler make-up water can be augmented with other sources if the available quantity of water is insufficient.

Utilization of Absorption Chilling—The benefits described previously can be derived by employing a direct or indirect conventional heat exchanger to utilize the waste heat and thermal plant cooling media. Such opportunities can be restrained by the layout and efficiency of conventional heat exchangers.

Examining details of the thermal plant heat balance shows other waste heat reuse options exist, but heat transfer can be constrained by the relative temperatures or the temperature differences between the two media for which heat transfer is desired. For these opportunities an absorption chiller can be applied to exploit low quality steam, or the heat contained in combustion flue gas, for the purpose of generating chilled water with low or no carbon footprint. An absorption chiller is similar to a vapor compression cycle system utilized in conventional air conditioning, allowing the transfer of heat from a lower temperature source to a higher temperature source, enabled by shaft work and/or a relatively small amount of electrical power. Details of absorption chillers are described in a series of publications from suppliers and the Department of Energy, whom are developing advanced versions that increase the effectiveness of heat transfer. The references listed at the end of this disclosure, all of which are incorporated herein by reference in their entireties, show the absorption chilling process, and describe the basis of their operation for one of skill in this field (DOE Tech Brief, DOE Steam Tips). Further, the previously cited EPA Report to Congress described the use of absorption or thermal chillers in CHP systems to provide for data center cooling.

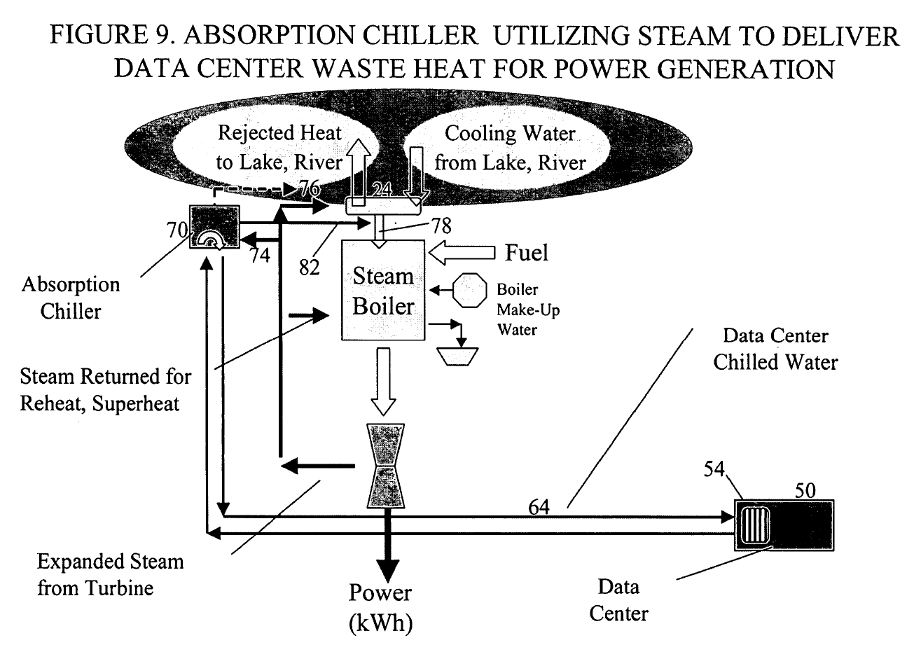

FIG. 9 presents an arrangement of an absorption chiller 70 and data center 50 integrated into the process steps of a thermal power station. FIG. 9 is not meant to restrict deployment of any type of absorption chiller in any way. For example, FIG. 9 does not restrict application to any specific absorption chiller type, as defined by the number of stages, or any other operating characteristics. A single stage (or single effect), or double stage (or double effect), or the evolving triple stage (or triple effect) can be utilized.

As shown in FIG. 9, an absorption chiller can utilize a (a) source of low quality heat such as steam 74 or alternatively hot water to regenerate the refrigerant media, (b) heat sink into which to reject heat 76, and optionally (c) an additional means to cool and promote the condensation of the refrigerant media 82. The same source of cooling media can be used to reject heat through step (b), and cool the refrigerant media in step (c). These process inputs, plus a small amount of mechanical shaft work to drive pumps, motors, and compressors, can provide a supply of cooled or chilled water 64 to the data center. The absorption chiller can employ either electrical or mechanical work to drive several compressors or pumps (not shown). The embodiment according to two sources of waste heat is described below.

Absorption Chiller Heat Sources: Low Quality Steam and Flue Gas. At least two sources of heat within the thermal power station can be utilized to drive the absorption chiller—low quality steam 74, or combustion products (e.g. flue gas), the latter following a boiler heat exchanger.

The utilization of steam after expansion by the steam turbine 74—featuring relatively low quality and low enthalpy—to provide heat to regenerate the refrigerant media within the absorption chiller is an ideal choice. As noted previously, low quality steam can have marginal value for the purpose of driving a steam turbine and generating power, but can still provide useful mechanical or thermal work. The enthalpy of the steam can be reduced by this heat loss within the generator section of the absorption chiller, and can utilize more feedwater heating or processing before returning to the boiler, which to a small degree can compromise the boiler thermal efficiency. However, this heat loss can be low depending on the steam pressure and temperature in relation to the condenser temperature, and as will be shown, can be compensated for.

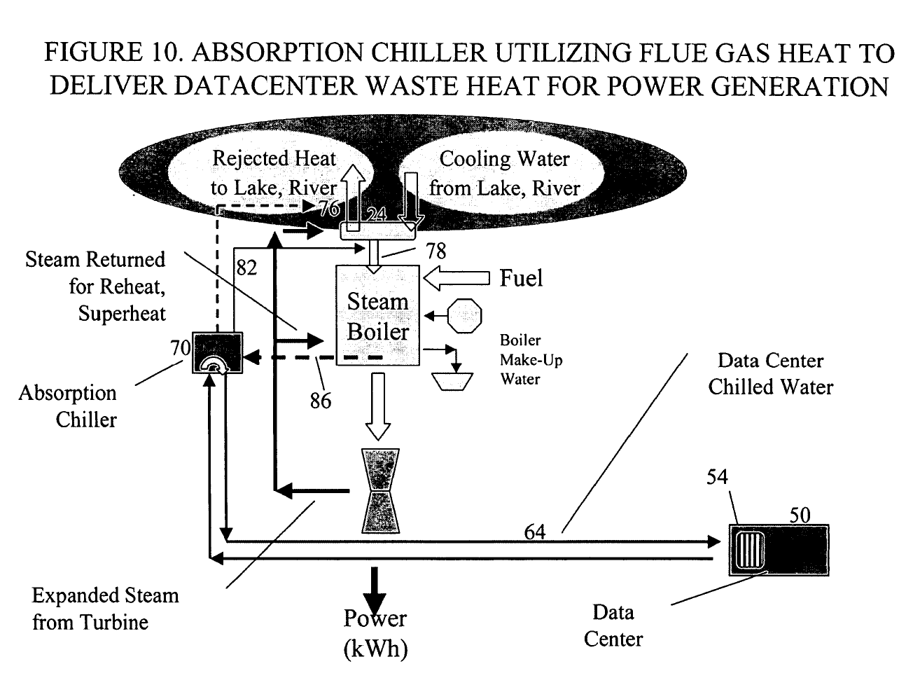

The second source of heat to drive the absorption chiller can be combustion products, or flue gas, at any point in the boiler. One of the locations from which to extract this flue gas is following the air preheater. As this flue gas—usually of a temperature between 275° F. and 350° F.—is accessed after this last heat exchanger, there may be no impact on boiler efficiency, as the latent heat contained in this flue gas would usually be discharged to the stack. FIG. 10 depicts a schematic of the absorption chiller configured to utilize waste heat following the boiler air heater (86), the last heat exchange device utilized in a power plant to regain heat. In embodiments, this waste heat can be accessed following both the air heater and the flue gas particulate collector—either an electrostatic precipitator (ESP) or fabric filter—as the near-zero particulate matter content of flue gas can enable a more effective and reliable heat exchanger. In concept, either the flue gas can be transported to the generator section of the absorption chiller as shown in FIG. 10, or the media within the absorption chiller to be heated can be transported to the boiler and exposed to the flue gas by an in-duct heat exchanger. A third option for the heat source is to use water heated by the flue gas to substitute for steam. The specific details of the equipment arrangement can depend on the site conditions, equipment layout, and the temperature of both the media to be heated and flue gas.

Absorption Chiller Heat Sinks: Station Heat Sink. Boiler Working Fluid. The thermal power station as depicted in FIGS. 9 and 10 offers two categories of ready sinks for heat to be rejected by the absorption chiller: (a) the body of cooling media utilized for thermal power station heat rejection 76, or (b) within the plant working steam or water cycle 78. Regarding (a), rejecting heat from the absorption chiller utilizing this method can exploit the thermal power plant heat rejection system, such as for plants with once-through cooling the existing thermal discharge zones. As such, in order to not compromise the thermal power station efficiency or power production, a location to reject heat from the absorption chiller can be physically following the location where the thermal plant condenser delivers the heat to the receiving body 76. Alternatively, for plants with cooling towers, heat can be rejected to the boiler cooling water after exiting the condenser and on return to the tower. A schematic depicting the use of absorption chillers with cooling towers as a source of cooling water will be presented subsequently.

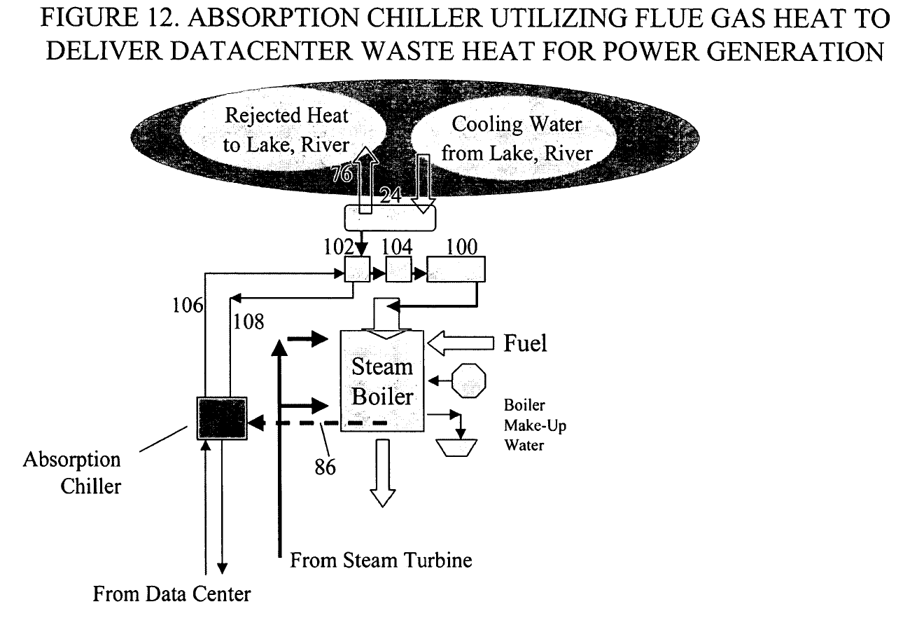

Regarding (b) in the previous paragraph, returning the waste heat from the data center to the boiler working fluid to further contribute to power generation can be useful in pursuing a low CO₂ emission, low carbon footprint data center operation. For example, there exist several points near the lowest temperature of the condensed steam after the condenser 78 to accept waste heat 76 and optionally 82. Further details of these examples are provided subsequently and explained in FIG. 12.

Optional embodiment: Steam-Driven Shaft Work. The absorption chiller can include several pumps, which conventionally can be electric power driven. Unlike a conventional vapor compression system, these pumps do not consume significant power, as they compress liquid and not gaseous media. As an alternative to electric driven compressors and pumps, a low pressure steam expander can be utilized to derive shaft work to operate the pumps and compressors. This can both lower operating costs and lower the carbon footprint of datacenter operation.

The manner of integrating and hosting a data center as depicted in the schematics in FIGS. 9 and 10 present examples of a compelling method for operating data centers, as will subsequently be shown in a quantitative example. Absorption chillers can also be used with other sources of water such as boiler make-up to provide cooling media. These cases will demonstrate that strong economic advantage can exist to the owner and operator of the datacenter.

EXEMPLARY MODES OF APPLICATION—A method of implementing and operating a datacenter within or adjacent to a thermal power station exists that can provide significant benefits to both the owner and operators of the datacenter, and the thermal power station. In fact, the needs are sufficiently aligned so that the data center could most expeditiously be operated as a joint business venture, between both parties.

The benefits are not limited by the relative size of the power station, or the power consumption of the data center. These benefits accrue regardless of whether a data center of conventional layout would consume 20 MW of electrical power, devoting 10 MW to operating the servers and 10 MW for cooling, and is hosted at a 75 MW plant; or whether the data center in total would consume 5 MW of power and be located within an 800 MW plant. The distribution and magnitude of benefits would differ, but all these benefits are anticipated to accrue.

Benefits of integrating the cooling needs of a data center with the cooling resources of a thermal power station utilizing the methods described in this disclosure can present the data center operator with the ability to obtain lower cost power, and possibly the least cost power, as the location within or adjacent to the power station can eliminate the cost of the power distribution network, and of delivering and distributing power over that network. Thus, the power costs are closely related to the production costs: fixed operating and maintenance, variable operating and maintenance, fuel, and any capital amortization.

Further, locating data centers at or near power generating stations will reduce long distance transmission line losses, which are estimated on a national U.S. basis to approximate 7% of total power generation, further reducing CO2 emissions attributable to data center operation.

It may be possible to lower operating costs by exploiting the need for both the power station and the datacenter to require 24×7 staffing. Even though the skills of the various technician and crafts trade for each respective enterprise may be different, there will be opportunities to extract cost savings by coordinating and managing the simultaneous maintenance of both functions. The same is true of consolidating security staff to prevent unauthorized access to the data center.

With this background, large cost savings are achievable by integrating the cooling needs of a data center with the cooling resources and needs of a thermal power station. The following scenarios illustrate how operations of the datacenter can be optimized. These scenarios are examples only, and do not necessarily restrict the operations to these cases.

Water Demand and Consumption-Prior to describing the modes of application, it is important to summarize the quantity of water that is available for cooling, and the amount of water required by the data center. Achieving a balance between these factors—the supply of cooling water from the power station and the demand by the data center—is important to identifying the specific method of implementation. Table 1 summarizes the water resources available for cooling at a large central thermal power station.

TABLE 1
Summary of Cooling Water Demands or Resources

| | Water Required |
|---|---|
| Water Cooling Method | (gpm per MW |
| or Water Function | capacity) |
| Once-Through Cooling | 600-700 |
| Boiler Water Make-up | 0.17 (at 1% blowdown) |
| Cooling Tower Make-up | |
| at 2 cycles of | 15 |
| concentration | |
| at 10 cycles of | 8.4 |
| concentration | |
| Cooling Tower | |
| Blowdown | |
| at 2 cycles of | 7.3 |
| concentration | |
| at 10 cycles of | 0.73 |
| concentration | |
| Typical Modular Data | 450 |
| Center Cooling | |
| Requirements (15 F. | |
| temperature rise) | |

It should be noted these water demands are approximate, and may change depending on the specifics of the application. For example, increasing the allowable temperature rise of data center cooling water from 15° to 25° F. can proportionately reduce the demand for cooling water.

Scenario A-Scenario A employs the steam boiler make-up water as a source of cooling water for the data center, and can further increase steam boiler and thus power plant efficiency by returning a small amount of the heat originally fired into the boiler. This option applies to plants that utilize any form of cooling: cooling towers, once-through cooling using either river, lake or ocean water. A schematic of this concept is depicted in FIG. 8. Scenario A may be feasible for the entirety of the year, depending on location. There may be some locations in warmer climates where the boiler make-up water as accessed from the supply is not low enough in temperature to provide for data center cooling, particularly in the summer. Under these conditions an absorption chiller can be utilized to lower the temperature of the make-up water to provide for such cooling, with waste heat rejected to the environment or utilized within the plant in any of the manners described in this disclosure. This scheme could be integrated with the utilization of a recuperative heat exchanger to recover heat rejected with the blowdown steam, cumulatively adding to the heat restored to the boiler water.

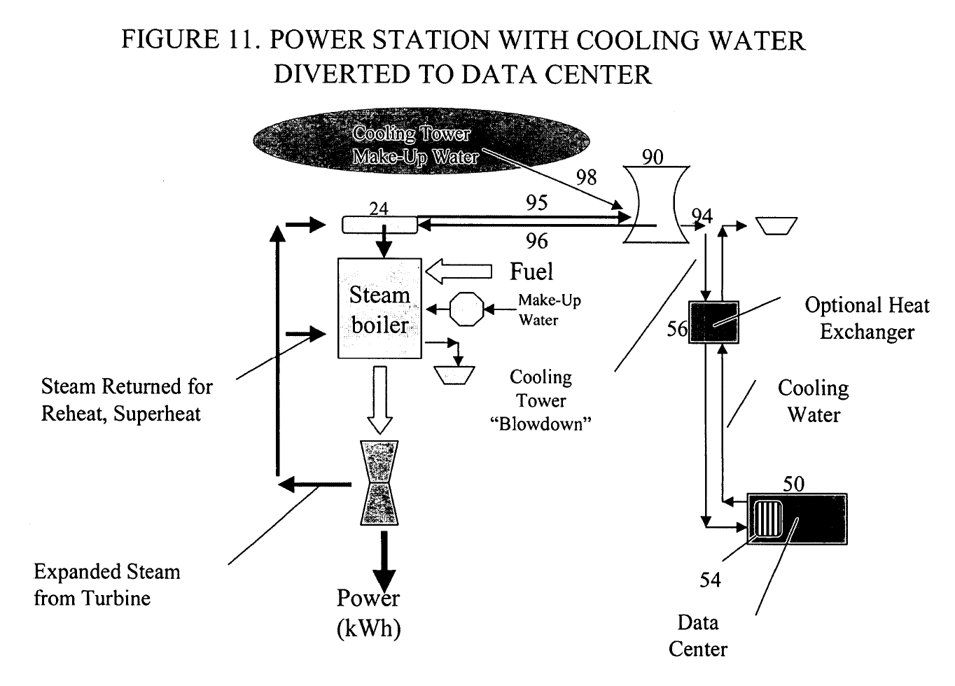

Scenario B—As shown in FIG. 11, for plants utilizing a cooling tower 90, the cooling tower blowdown 94 or discharge stream can be used as a source of cooling water. The cooling tower can reduce the temperature of water from the condenser 95 and returns cooled effluent 96 to the boiler. The water losses due to evaporation and cooling tower blowdown can be compensated for by make-up water 98 from well sources or a lake, river, or other body.

This effluent cooling tower blowdown stream 94—usually high in chlorides, total dissolved solids, and other impurities—is treated and in many cases discharged to a receiving water body. At some sites the cooling tower blowdown discharge is used for make-up water for the flue gas desulfurization (FGD) process. The cooling tower discharge temperature is the same as water leaving the cooling tower and going to the boiler condenser, and thus represents a source of cooling medium. In many cases, this discharge temperature can be within 5° F. to 8° F. of the ambient air wet bulb temperature.

If the cooling tower discharge water is utilized directly in the data center heat exchangers 54, the materials of construction can include non-conventional and perhaps exotic materials to avoid corrosion, and perhaps also be equipped with apparatus to avoid fouling of heat exchange surfaces. This scenario may not be costly—the data center heat exchangers are relatively small in the context of power plant heat exchangers, and utilizing back-up equipment may enable planned maintenance to attain high availability. An alternative can be to utilize the cooling tower blowdown and the indirect heat exchanger 56, thus exposing the data center heat exchanger exclusively to high quality water to avoid fouling.

Scenario B may be feasible for part or the entirety of the year, depending on location. The extent to which Scenario B can be utilized for 12 months throughout the year can depend on the month-by-month variation of the wet bulb temperature, which establishes the minimum temperature at which the cooling water can be derived. For example, in some climates like Atlanta, Ga. the average wet bulb temperature is 45° F. and 70° F. in the winter and summer, respectively. At this location the concept of using cooling tower blowdown in the winter is feasible, as cooled water of approximately 50° F. to 54° F. is available. However, cooling tower blowdown temperatures of 75° to 79° F. are delivered in the summer, limiting the usefulness this concept.

There are several means to augment the cooling provided by the cooling tower blowdown during the summer periods, using methods that have been previously described in this disclosure. First and most simply, the cooling tower make-up water 98 can be applied in the place of the cooling tower blowdown. In general, the temperature of water in the source can be related to the average ambient temperature; subsurface water can be several degrees cooler. If subsurface temperatures available still exceeds the target, an absorption chiller can be utilized to lower the temperature of this cooling media. The absorption chiller can be driven by either or a combination of waste heat, hot water, low quality steam or flue gas, increasing opportunity for low CO₂ impact. A schematic depicting this arrangement is presented subsequently.

Scenario C—For plants with once-through cooling that utilize river, lake, or ocean water, the intake structure can be utilized to divert cooling water from this medium directly to the data center, for utilization in any manner of cooling. FIG. 6 depicts this process schematic. Some embodiments can include a indirect heat exchanger so that river, lake, or ocean water does not have to be treated or processed to contact the data center heat exchangers; this river, lake, or ocean water can cool a secondary medium of high quality water (not unlike processed boiler feedwater) that is utilized within the data center. Alternatively, if a corrosion and deposit-resistant heat exchanger can be built to operate within the data center, this cooling medium can be used directly. The heated water can be returned to the river, lake, or ocean downstream of the power plant thermal discharge point.

This arrangement may be the most cost effective, pending ambient temperatures, and discharge permit limits on water use. Scenario C may be feasible for only part of the year, and may have to be augmented by another scenario for year-round operation. Specifically, the following implementation may be utilized depending on whether the limit in cooling water use is incurred:

Maximum cooling water intake. If the water utilized for power station once-through cooling is equal to the maximum value allowed by the permit, additional water removal may not be possible and data center cooling should necessarily divert cooling water from the boiler condenser. However, there can be periods when the maximum capability of the boiler condenser cooling system configuration may not be needed to achieve the maximum plant output or thermal efficiency. A representation of this case has been presented in FIG. 5. A control system can be designed and implemented in which the relationship between boiler condenser cooling water and the static pressure within the condenser can be monitored, as depicted in FIG. 5, when operating in the regimes of cooling water flow rate and static pressure as described by conditions D and E. Instead of static pressure within the condenser, some other parameter related to boiler efficiency can be utilized as a surrogate. Regardless, at these conditions when cooling water is in excess of what is needed, said cooling water can be diverted to data center cooling without sacrificing plant output or heat rate.

There could be periods when the maximum cooling water flow rate should be utilized for boiler thermal efficiency, or when the ambient cooling water body is relatively high in temperature and may not provide for sufficient cooling for either the data center or boiler condenser. Under these conditions data center cooling can employ an absorption chiller as previously shown in FIG. 9 or FIG. 10. An optimal approach may depend on the period of time or duration the ambient cooling water body cannot provide data center cooling, and the capital cost of implementing the absorption chiller.

Excess Cooling Water Intake. Some plants, due to their specific water use permit conditions and configuration of the cooling system, may not require the full capacity of cooling water available at the site or allowed by permit. Alternatively, most water use permits are issued not specifically for the boiler condenser of any one unit but for an entire generating station, covering other in-plant uses, and the needs of any other generating units at the site. Under these conditions an excess of water availability may exist, particularly at a station with multiple units where one or more of these units is operating at lower than design generating duty.

Under these conditions, water can be extracted for data center cooling, but in a way to not restrict the flowrate of water available to the boiler condenser. Specifically, either a separate water intake structure, an intake structure designed for another unit at the station either not in use or underutilized, or for any other plant uses, can be modified to provide cooling for the data center. The flow rate directed to the data center cooling medium is to be monitored and compared to the calculated or measured flow rate through generating units that fully utilize the cooling resources. These steps will provide the necessary information to demonstrate that data center cooling needs are provided for separately and without compromise to the plant heat rate or power output, to within a degree of uncertainty equivalent to the accuracy of flow rate and heat rate measurement.

It should be noted that any available cooling water acquired from the cooling intake structure can be used to support the operation of an absorption chiller, installed as depicted in FIGS. 9 and 10, or in another suitable manner. In this manner the absorption chiller can operate with minimal impact on thermal power station plant heat rate or power output.

Scenario D—Scenario D utilizes an absorption chiller, similar to the manner as described in FIGS. 9 and 10, to extract heat from either process steam or flue gas exiting the boiler. The heat can be injected or transferred into the cooling body 76 downstream or remote from the boiler condenser 24, so as not to interfere with the heat rejection of the host power station. The ability to transfer heat to the cooling body downstream of the power plant condenser will depend on the specifics of the plant cooling system, and the thermal discharge permit. In northern climates such access to heat transfer zones downstream of the power station will likely be greater than in southern climates, as ambient water in the latter cases is 80° F. to 90° F. in the summer. Under these conditions, a small cooling tower or “helper” tower can be used to augment cooling of both the power station and the data center.

As stated for Scenario C, operation of the absorption chiller in this scenario can utilize the cooling water from the cooling lake or river or other body, without impact on thermal power station output or heat rate. Any of the systems or equipment to be described subsequently in Scenario E to acquire cooling water to support operation of the absorption chiller, specifically the cooling steps, can be applied in Scenario D.

Scenario E—Scenario E utilizes the absorption chiller to leverage the delivery of data center waste heat not to the ambient environment, but to a sink within the boiler steam condensate (78 of FIG. 9 or 10), that allows the data center waste heat to be utilized for power generation. The benefits of this scheme are not dependent on the temperature of the media to which the heat is rejected, or how the absorption chiller is configured, but simply the utilization of the absorption chiller to transfer heat from the data center to a sink that increases the power generated and thermal efficiency of the host unit. Scenario E represents perhaps the highest payoff, highest cost effective approach—returning the waste heat produced by the data center to the power plant to augment power generation, through the feedwater heater or other ways. This can be accomplished in several scenarios.

Notably, the preceding discussion has described several scenarios, as though each were conducted separately. In reality, the mixing or blending of more than one scenario may be the best choice. In winter months, the use of direct once-through cooling water from a river, lake or steam (Scenario C) may be the best choice, but during the summer months when the ambient temperature of the cooling water body increases, the use of an absorption chiller in any of the manners previously described (e.g. such as Scenario D) may be best. The period of transition between moving from one cooling mode such as Scenario C to another such as Scenario D will be gradual, and both scenarios of cooling used contemporaneously or simultaneously. In effect, the various scenarios described offer a system approach to cooling data centers throughout the year.

FIG. 12 depicts a schematic of the boiler and power plant arrangement presented in either FIG. 9 or 10, with the exception that additional heat transfer surfaces between the condenser and the boiler feedwater heater are shown. The state-of-art steam cycle is regenerative, in that various components of steam are extracted at different locations, and can be reheated or merged with other streams, depending on the specific configuration. FIG. 12 shows the location of the feedwater heater 100, a tool to assure high boiler thermal efficiency is attained, in more detail. As shown, steam leaving the condenser 24 section can proceed into the feedwater heater 100, during which heat from other sources internal to the power station can be utilized to preheat the water temperature. Specifically, the condensate from the condenser 24 on the way to the first stage of the feedwater heater 100 can be utilized to lower the temperature of other circulating media, for example in heat exchangers in contact with hydrogen 102 and lubricating oils 104 that both contact the steam turbine bearings. The benefit of transferring heat from the higher temperature lubricating oil and bearing cooling hydrogen to the condensate is that power station plant thermal efficiency improves. This location is a good region into which to introduce waste heat from the data center. The utilization of feedwater preheating is an effective way to retrofit improvements to the heat cycle.

The case of hosting a data center at a power station presents a very unique opportunity to recycle some of the generated power that is not obvious. As stated previously, the source of the waste heat in a data center is the microprocessors—with heat generated as a byproduct of the microprocessor operation (and to a lesser extent, the hard drive, memory device, etc.). Thus, waste heat is generated from electrical power consumed; and for the case of integrating the cooling needs of a data center into the cooling resources of a power station, the waste heat 106 is essentially recycled back to the steam generator, to contribute to power generation. Of course, returning this waste heat to the boiler for useful work can only be accomplished at a price. If a direct or indirect heat exchanger is used, the size of the heat exchangers required will be increased. If an absorption chiller is used, the price is the heat or steam utilized to drive the process, that should be considered. Unavoidable losses dictated by the second law of thermodynamics assure that the waste heat returned can never replace the power consumed by the data center. However, the transfer of waste heat from the data center 106 to the boiler provides an improvement to simply dispersing the heat into the environment.

The concept of returning waste heat from the data center to the boiler, to contribute to additional power production, is not dependent on the specifics of the absorbent chiller layout—a single stage (or single effect), dual stage, or triple stage as presently being developed can be utilized, depending on the specific needs. Low quality steam or waste heat 86 or hot water from the boiler can be utilized to generate the absorbent media, and heat from the data center can be delivered into the low temperature condensate, such as through the feedwater heater, or heat exchangers preceding this device.

As stated previously, any optional additional cooling media that may be necessary to lower the temperature of the refrigerant upon leaving the generator (not shown) can be provided by any sources of intermediate-temperature water or other media that are available within the plant.

Supplementary Cooling-Several scenarios previously described address the observation that during certain portions of the year, particularly summer, the ambient temperature of the cooling water body or the effluent from the cooling tower as determined by the wet bulb temperature could be inadequate in terms of either volume of temperature (e.g. for example, in at least some embodiments less than 65° F.) to provide adequate cooling. Under these conditions an absorption chiller can provide supplementary cooling. The size of the absorption chiller for this type of duty will depend on the specifics of the application, and can be small if the role is to augment cooling from the primary cooling media.

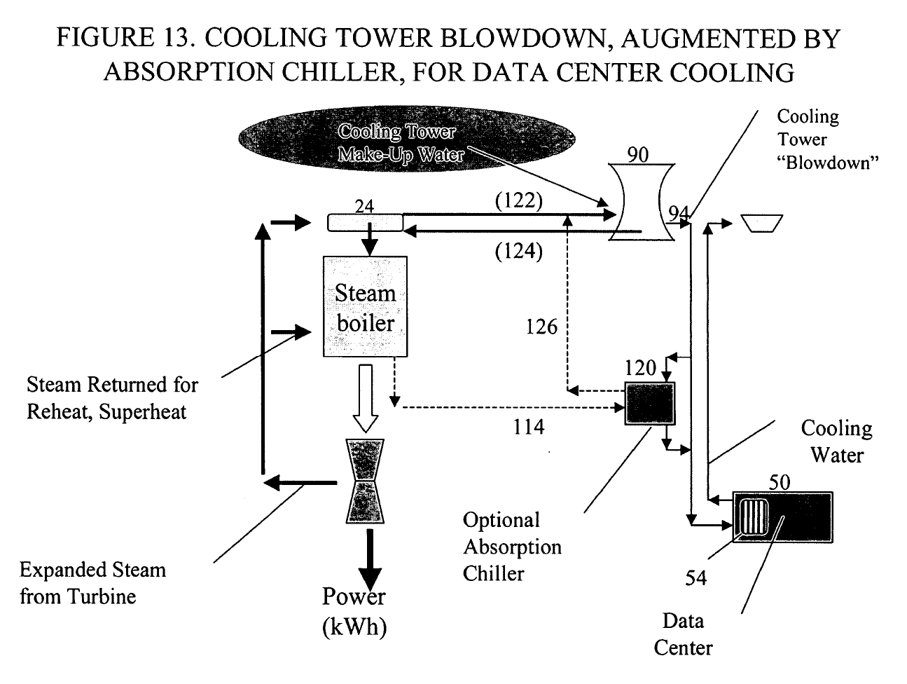

FIG. 13 depicts an arrangement where cooling tower blowdown 94 from a cooling tower 90 is utilized for data center cooling, but for a few summer months the temperature exceeds the target of 65° F. and an absorption chiller 120 is used to lower the temperature of cooling tower blowdown 94. The cooling tower receives boiler condensate 122 and returns cooled effluent 124 to the boiler. Similar to the application of an absorption chiller described for the case of once through cooling, low quality steam 114 can be utilized as the heat source to generate the refrigerant within the absorption chiller. Waste heat 126 would be rejected from the absorption chiller 120 back to the condenser effluent 122 to the cooling tower, in either case to be rejected to the cooling tower, or even to any excess cooling tower blowdown (not shown). Rejecting heat to cooling tower effluent in transit to the boiler 124 can compromise heat rate, but rejecting heat to condensate from the boiler 122 or any excess cooling tower blowdown (not shown) should not materially affect heat rate. This optional arrangement may be utilized for example for only short periods of time where the temperature of the cooling tower blowdown 94 is too high (e.g. above approximately 65° F.) to provide for data center cooling. Further, this concept would be applicable only when the cooling tower blowdown exceeds the target of 65° F. by less than approximately 10° F. to 12° F.; otherwise alternative ways to deploy absorption chillers would be utilized that are lower cost.

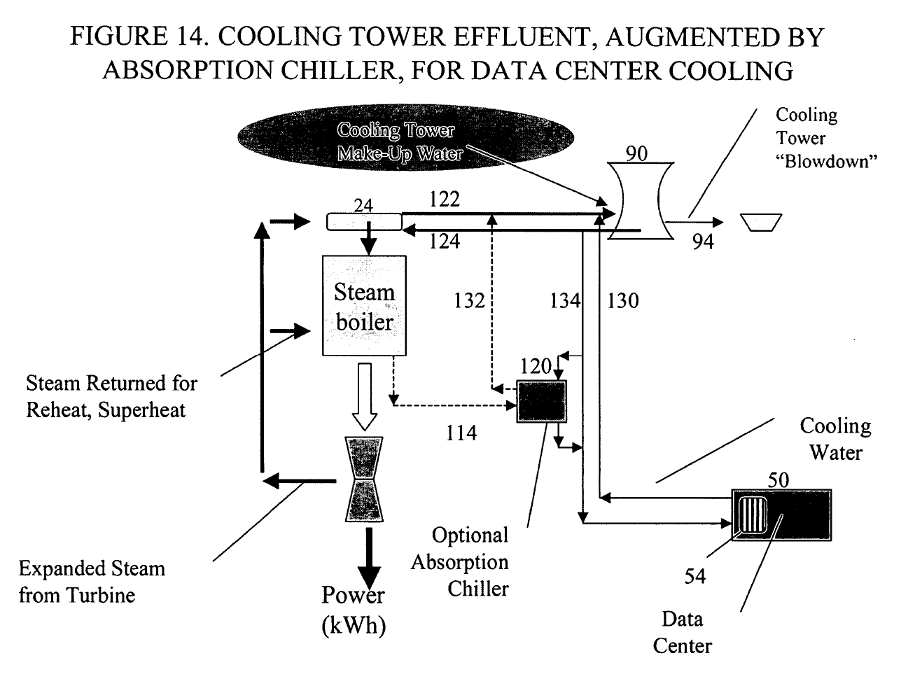

FIG. 14 depicts a similar arrangement where the cooling tower effluent 124 provides a small bleed stream 134 for data center cooling, and optionally an absorption chiller 120 can be utilized to augment the data center cooling in summer months. The absorption chiller 120 can utilize low quality steam 114 to drive the process, or hot water, and heat rejected by the absorption chiller 132 can be returned to the cooling tower using the effluent from the condenser 122. As an alternative to using steam to drive the absorption chiller, flue gas from the boiler preferably following the particulate collector could be used, or hot water generated by this flue gas. This arrangement, in which the heat is returned to the cooling tower for heat rejection, could compromise plant heat rate, as cooled water effluent from the cooling tower is diverted for purposes other than power station cooling. However, the relative impact could be small depending on the relative influence of condenser flow rate cooling water on condenser backpressure, as depicted in FIG. 5. If the relationship between additional cooling water flow rate and condenser static pressure is similar to FIG. 5, then any excess capacity of the cooling tower will be able to service the data center with only negligible impact on power plant efficiency.

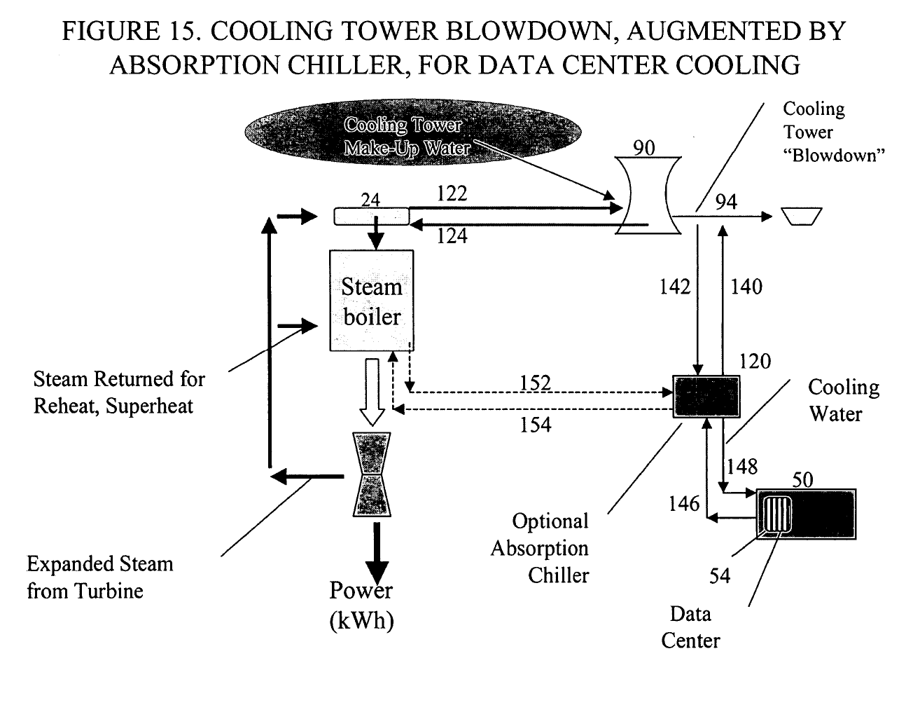

FIG. 15 represents one possible embodiment for integrating the needs of data center cooling with a thermal power station equipped with cooling towers, providing for data center cooling with low carbon emissions and low operating cost. FIG. 15 shows an embodiment employing the cooling tower 90 and effluent cooling tower blowdown 94. This figure depicts the case of using the absorption chiller 120 in a closed cooling water circuit with the data center heat exchangers 54, recirculating water that is processed at up to 65° F. 148 for cooling and is returned to the absorption chiller 146 for heat removal. In this case, the cooling tower blowdown is used not to provide direct cooling to the data center, but for heat removal from the absorption chiller, through a supply of water for cooling 142 and a return stream 140 for disposal and discharge to a cooling pond or basin. The heat source for the absorption chiller is preferably flue gas extracted from downstream of the air heater 152, and returned to the boiler to the flue gas handling system (154). Alternatively low quality steam or hot water generated by the flue gas could be applied as described for previous embodiments (not shown). The arrangement in FIG. 15 can be deployed either permanently throughout the year, or only when cooling tower blowdown may not be low enough in temperature (e.g. approximately 65° F. or less) to exclusively provide for data center cooling.

The embodiment depicted in FIG. 15 is chosen as the basis for a quantitative example of how various flow rates from the cooling tower and absorption chiller can be used to design a practical system. For this case, the power plant is assumed to generate 500 MW capacity, and discharge cooling tower blowdown of 5 gpm per MW, thus producing 2500 gpm of water for data center cooling. For many months throughout the year, the blowdown generated is at a temperature of 65° F. or less, and can be used directly for data center cooling, as previously shown in FIG. 11. However, as an example, for a period of 4 months of the year the blowdown exceeds 65° F., and can be as high as 85° F. Under these conditions the closed cycle heat exchanger concept, using the cooling tower blowdown for heat rejection is employed. Reducing the temperature of the cooling tower blowdown as described in FIG. 14 will consume a large amount of steam, cooling water, and capital; accordingly this embodiment is not preferred when the temperature is to be reduced by more than approximately 10° to 12° F. The data center is assumed to consume 2.8 MW of electrical power to operate the servers, and generates approximately the equivalent power as heat, to be rejected by the data center heat exchangers. In this case, the data center heat exchangers require 1250 gpm of cooling water, which enters the data center heat exchangers at 65° F. and is returned at 80° F. The absorption chiller is intended to lower the temperature of the data center cooling water from 80° F. to 65° F., and thus requires almost 725 tons of cooling per hour.

A commercial absorption chiller capable of 750 tons of cooling, for example in this case a Trane Model ABSD700 single stage chiller, can be used. The manufacturer's specifications state the chiller requires 17.7 lbs of 12 psig steam, per ton of cooling, per hour of operation. To service this heat load, the total steam flow is then 12,777 lbs hr, equal to about 0.33% of the unit steam throughput. Alternatively, hot combustion products or flue gas of about 325° F. can be used in place of the steam. The manufacturer's data also states the absorption chiller will require approximately 2500 gpm of cooling water at a maximum of 85° F., which is equal to the cooling tower blowdown discharged. Other requirements include minor amounts of electrical power. This example shows that a straightforward application of a commercial absorption chiller using cooling tower blowdown can service the needs of a large data center at a 500 MW power station.

Summary of Example Modes of Application

Table 2 summarizes several modes of application described in this disclosure, identifying the advantages and citing why these choices are not obvious to the usual science or art. For each case, the option is described, and the advantages of integrating the cooling needs of the data center with the power station. This method is contrasted to the conventional practice of employing a dedicated, stand-alone cooling system for the data center. These Case studies, designated from Case 1a through Case 7, are selected examples, and are not intended to constrain the possible applications. The benefits of several of these cases are quantified in the subsequent section.

TABLE 2
Example Modes of Utilizing Thermal Power Station Cooling
Resources For Data Center Cooling

| | | Integrate With Central | Dedicated System for |
|---|---|---|---|
| Case | Option | Thermal Power Station | Data Center Cooling |
| 1a | Use cooling | Water use authorized by | Need to acquire water |
| | water from local | existing thermal power | extraction rights from |
| | water body or | station water permit | water body |
| | source, acquiring | Access to select lower | Need to construct |
| | cooling water | temperature cooling water, | dedicated infrastructure |
| | from power | pending design of intake | for cooling water |
| | station intake | structure | withdrawal, distribution, |
| | structure, for | Use existing infrastructure | return, and pumping. |
| | direct use by data | for the transfer, routing, | |
| | center heat exchangers. | distribution, and pumping of | |
| | | water | |
| | | 4. Exploit underutilized | |
| | | thermal power station | |
| | | cooling resources, at low | |
| | | load, or in winter. | |
| 1b | Use cooling | Same as Case 1a, except | Same as 1a. |
| | water from local | cooling water use terminated | |
| | water body or | or minimized when | |
| | source, acquiring | measurements such as | |
| | cooling water | condenser backpressure | |
| | from power | indicate detrimental plant | |
| | station intake | heat rate impact. Alternative | |
| | structure, for | cooling option required when | |
| | direct use by data | plant heat rate negatively | |
| | center heat | impacted. | |
| | exchangers, and | | |
| | monitor cooling | | |
| | water flow rate | | |
| | withdrawn, or an | | |
| | indicator of plant | | |
| | heat rate. | | |
| 2a | Apply cooling | Utilize existing cooling tower, | Dedicated data center |
| | tower output | designed and built to support | cooling tower will incur |
| | intended for | power station cooling | higher unit capital cost, |
| | boiler for direct | requirements, thereby | and possibly |
| | cooling of data | exploiting economies of | compromised cooling |
| | center heat | scale. | effectiveness |
| | exchangers. | Use existing O&M staff, | Dedicated O&M staff |
| | | piping, and pumping | necessary |
| | | infrastructure. | New infrastructure for |
| | | Exploit excess cooling | water supply, delivery, |
| | | capacity at low load, winter | control |
| | | conditions | |
| 2b | Apply cooling | Same as Case 2a, except | Same as 2a |
| | tower output | the cooling tower output is | |
| | intended for | terminated or minimized | |
| | boiler for direct | when detrimental plant heat | |
| | cooling of data | rate impact is detected. | |
| | center heat | Alternative cooling option | |
| | exchangers, | required when plant heat | |
| | monitoring | rate negatively impacted. | |
| | cooling water | | |
| | flowrate | | |
| | withdrawn, or an | | |
| | indicator of plant | | |
| | heat rate, | | |
| | supplemented as | | |
| | needed. | | |
| 3a | Cooling tower | Utilize cooling tower | N/A |
| | blowdown, for | byproduct that is at the same | |
| | direct or indirect | temperature as the cooling | |
| | cooling of data | tower output; the data center | |
| | center heat | can utilize this waste stream | |
| | exchangers | without impact on plant heat | |
| | | rate | |
| 3b | Cooling tower | Same as Case 3a, but | N/A |
| | blowdown for | supplement cooling as | |
| | direct or indirect | needed if and when cooling | |
| | cooling (part of | tower blowdown provides | |
| | year), | inadequate cooling | |
| | supplemented by | | |
| | absorption chiller | | |
| 4 | Apply absorption | Use existing thermal power | Same as 1a. |
| | chiller for data | station infrastructure for | |
| | center cooling, | once-through cooling to | |
| | using cooling | reject heat from the data | |
| | water from local | center. | |
| | cooling body to | | |
| | reject heat from | | |
| | the absorption | | |
| | chiller | | |
| 5 | Apply absorption | Use existing thermal power | Same as 2a. |
| | chiller for data | station cooling tower to | |
| | center cooling, | reject heat from the data | |
| | using cooling | center. | |
| | tower output to | | |
| | reject heat from | | |
| | the absorption | | |
| | chiller | | |
| 6 | Apply absorption | Heat rejected by the data | This option is not |
| | chiller for data | center is returned to the | available for a dedicated |
| | center cooling, | boiler to preheat water and | data center cooling |
| | using boiler | contribute to power | system. |
| | condenser water | generation. | |
| | as the means to | 2. The source of heat to | |
| | reject heat from | drive the absorption chiller | |
| | the absorption | can be either low quality | |
| | chiller | steam or combustion | |
| | | products | |
| 7 | Use water | Direct heat rejected from the | This option is not |
| | intended for | data center for boiler | available for a dedicated |
| | boiler make-up | heating, contributing to | data center cooling |
| | for cooling. | improving plant heat rate or | system. |
| | | output. | |

Case 1a. The direct utilization of cooling water from a local river, lake, or ocean is applied, ideally from the thermal power station intake structure and using the power station cooling water circuitry and distribution network. Diverting cooling water from the steam boiler, under some conditions such as full load and high ambient temperatures, could compromise plant heat rate and thus increase CO₂ production from the thermal power station, as a consequence of providing for data center cooling. The conventional approach in siting or designing a data center is for the data center operator to acquire dedicated cooling water resources, necessitating new or additional infrastructure and acquiring the necessary water use permits. The conventional approach to providing cooling for a data center would not recognize that diverting a portion of cooling water from a thermal power station, usually acquired from the bottom of a cooling water body at a distance remote from the shoreline to ensure minimum temperature, will not for a portion of operating time degrade plant heat rate, depending on generating load, and time of year of operation. Accordingly, this conventional approach would not identify thermal power station cooling resources as assets to utilize.

Case 1b. In Case 1b, either the thermal power station operator or the data center operator takes explicit steps to determine the increase in CO₂ attributable to data center cooling, and initiate alternative cooling means. Either the thermal power station operator or data center operator will monitor any of several indices that describe if, and when, diverting cooling resources from the thermal power station to the data center compromises plant heat rate, and thus increases CO₂ production. These indices can be as simple as the flow rate of cooling water diverted to the data center, the flowrate of cooling water that is processed by the condenser, the cooling water temperature entering and exiting the boiler condenser, or the condenser backpressure. Any of these other indices can detect if plant heat rate is compromised and higher CO₂ emissions are incurred that are attributable to data center cooling.

If higher CO₂ production is not to be incurred by the thermal power station under any conditions, supplementary cooling such as with a “helper” or auxiliary cooling tower, or a small absorption chiller could be utilized. As such devices would be used for partial duty; they will be smaller in size and only modestly affect operating cost.

Case 2a. Case 2a is analogous to Case 1a in that cooling resources designed and dedicated to the thermal power station are diverted to data center cooling. In Case 2a, the cooling water exiting the cooling tower is used by the data center for direct cooling of heat exchangers. The same constraints and opportunities apply as for Case 1a—under some conditions, particularly high load and high ambient temperature, diverting cooling resources in this manner to a data center can compromise thermal power station heat rate and impart higher CO₂ emissions attributable to data center cooling. However, under many operating conditions there would be no plant heat rate and CO₂ emissions impact of data center cooling.

The conventional approach to providing cooling, or selecting a location for, a data center would not recognize that for some periods of time a thermal power station will have excess cooling resources. These excess cooling resources allow diverting a portion of cooling water from a thermal power station without degrading plant heat rate, depending on generating load, and time of year of operation. Accordingly, this conventional approach would not identify thermal power station cooling resources as assets to utilize.

Case 2b. Case 2b is analogous to Case 1b in that the operator of the thermal power station or the data center monitors any of several indices that reflect the influence of diverting cooling water from the cooling tower to the steam boiler condenser, and determine when the thermal power station incurs a heat rate penalty and higher CO₂ production attributable to data center cooling.

If higher CO₂ production is not to be incurred by the thermal power station under any conditions, supplementary cooling such as with a “helper” or auxiliary cooling tower, or a small absorption chiller could be utilized. As such devices would be used only for partial duty; they will be smaller in size and only modestly affect operating cost.

The conventional approach for providing cooling to, or selecting the site for, a data center does not recognize that thermal power stations can feature excess cooling resources for periods of time that can be monitored to access or supplement as appropriate.

Case 3a. This case entails the use of cooling tower blowdown as the source for direct or indirect data center cooling. As the temperature of the cooling tower blowdown is the same as the temperature of water exiting the cooling tower, this media provides an opportunity for direct data center cooling. The cooling tower blowdown in concept would be utilized, and then subjected to the same water treatment processing and discharge steps as conventionally applied.

The conventional approach for providing cooling resources to, or siting of, a data center does not recognize that cooling tower blowdown, normally considered a waste stream, can provide cooling resources prior to treatment and discharge.

Case 3b. Case 3b entails the use of cooling tower blowdown as described in Case 3a, but recognizes that for periods of time such as when high ambient temperatures are incurred, the amount of cooling may have to be supplemented by other means. As described previously, these could be a small “helper” cooling tower or thermal absorption chiller.

Case 4. Case 4 includes applying an absorption chiller for providing cooling water for use in the data center heat exchangers. In Case 4, the heat from the data centers that is removed by the thermal absorption chiller is rejected to cooling water acquired from a river, lake, or stream, possibly using the thermal power station intake and other infrastructure.

The utilization of absorption chillers to provide data center cooling is not new, but configuring the design so to use the excess cooling resources of a thermal power station as means to dispose heat is new and novel. Conventional logic would provide the absorption chillers with a separate dedicated cooling system, and/or not recognize that thermal power station can feature excess cooling capacity for periods of operation.

Case 5. Case 5 includes applying an absorption chiller for providing cooling water for use in the data center heat exchangers. In Case 5, the heat from the data centers that is removed by the thermal absorption chiller is rejected to cooling water acquired from a cooling tower, which is intended for the steam boiler condenser, but diverted to the thermal absorption chiller. As with Case 4, conventional logic would provide the absorption chiller with a separate dedicated cooling system, or not recognize that thermal power station can feature excess cooling capacity for periods of operation.

Case 6. Case 6 includes applying an absorption chiller for providing cooling water for use in the data center heat exchangers, where the heat removed from the data centers by the thermal absorption chiller is returned to steam boiler condensate water, to either increase power output or improve plant heat rate. The scenario effectively recycles heat to the steam boiler for additional power generation.

Case 7. This case entails utilizing boiler make-up water for direct data center cooling, diverting the make-up water to the data center heat exchanger either before or preceding treatment to remove impurities that can compromise boiler performance or integrity. Consequently, the heat generated by the data center is returned to the boiler for either greater power production, or improving plant heat rate. Similar to Case 6, this scenario effectively recycles heat to the steam boiler for additional power generation.

QUANTIFYING THE BENEFITS TO THE DATA CENTER—The benefits to the data center can be quantified for several of the cases described. These examples are not comprehensive for all applications, but show how the operator of a data center can extract economies of scale by integrating the cooling needs of a data center with the cooling resources of a thermal power station.

These examples are based on a reference data center configuration comprised of a total of 10 modular data center units, consuming a total of 2.75 MW to operate. The quantities of power required, waste heat generated, and cooling resources needed are exemplary only. Conditions have been selected to represent typical practice, but individual units or other applications can exhibit different results. The analysis is based on assuming a net utilization rate of the servers of 80%, and an additional 7% power demand for auxiliary power for lighting and ancillary needs. The power station operator is assumed to derive a market value of power produced $60/MWh; accordingly the power demand for server operation, lighting, and ancillary services is 2.94 MW; the annual cost to provide this power is $1,237,262.

Table 3 summarizes the cost implications of several of the previously described cases.

TABLE 3
Summary of Data Center Operating Costs With Various
Cooling Strategies

| | Baseline Case | Case 1a | Case 4 | Case 6 |
|---|---|---|---|---|
| | Conventional HVAC | Divert Existing | Thermal | Thermal |
| Cooling Concept | w/Cooling towers | Cooling Water | Absorption Chiller | Absorption Chiller |
| Capital Equipment | 700,000 | 150,000 | 700,000 | 1,000,000 |
| Fixed O&M (at 5%) | 35,000 | 7,500 | 35,000 | 50,000 |
| Auxiliary Power, kwh | 350,000 | 20,000 | 30,000 | 30,000 |
| Other Variable Operations | 20,000 | 20000 | 20000 | 20,000 |
| Water Cost | 3,000 | 1,000 | 1,000 | 1,000 |
| Finance Charge | 119,000 | 25,500 | 119,000 | 170,000 |
| Operating Cost, Excluding Server Power | 527,000 | 74,000 | 205,000 | 271,000 |
| Server Operating Cost | 1,237,262 | 1,237,262 | 1,237,262 | 927,947 |
| Total Data Center Operating Cost | 1,764,262 | 1,311,262 | 1,442,262 | 1,198,947 |

Table 3 describes a baseline case, where a stand-alone or modular data center unit is used in which a conventional vapor compression chilled water system, with dedicated cooling towers. For the Baseline case, the 2.9 MW data center servers operate at 80% utilization and, along with the ancillary services, require $1.237 M in annual operations. The Baseline case employs a chilled water system, consisting of a vapor compression system and a small cooling tower, requiring a capital investment of $700,000. The electrical costs to operate the chilled water systems to provide 65 F water are about $350,000 annually; an additional $35,000 for fixed operations and maintenance, $20,000 for other variable operations, and $3,000 for process water are required, totaling $58,000 annually for non-power operations. Assuming a capital recovery factor or finance charge of 17% for equipment with a ten year lifetime, the annual payment for capital is $119,000. Accordingly, the total annual operating cost for this baseline scenario is $1.764 M.

This value represents a reference case against which savings reductions in subsequent cases can be compared.

Operating costs are presented for Case 1a, Case 4, and Case 6. The example for Case 1a, which employs thermal plant cooling water for direct process cooling, incurs a capital charge is $150,000 to install cooling water recirculation pipes to distribute the cooling water to the data center. The location of this example unit is in a northern latitude with a deep lake, with cooling water access withdrawn from the center of the lake as typical for power stations, so that solely cooling by this water source is necessary. Further, the data center owner compensates the thermal power station maintenance staff for a portion of fixed and variable operations and maintenance of the cooling tower, at about $27,500. At a fixed capital recovery charge of 17%, an annual sum of $25,500 is need for capital recovery, in addition to operations. Including all costs, total operating power and cooling require an annual charge of $1.31 M. Compared to the Baseline case, Case 1a defined by integrating the cooling needs of a data center with the cooling resources of a central power station provides significant savings over employing stand-alone, modular cooling and power generation systems.

The example for Case 4 provides a compelling case for the benefits of using an absorption chiller, to reduce cooling costs and mitigating CO₂ emissions. For this case, the capital cost of the absorption chiller is assumed to be $700,000 to provide the required cooling, and access cooling water from the cooling water body. The operating costs excluding server power are estimated to total $205,000, and thus total operating costs including server power are $1.44 M.

Finally, Case 6 exemplifies the most compelling case, where heat generated by the servers is returned to the power station, for additional power generation. Assuming the thermal power station features a typical thermal efficiency of 35%, this heat is then converted back to power, at this same thermal efficiency rate. Thus, about one-third of the power required for the data center is provided by the data center itself. In the present example, the power cost for server operations can be considered to be discounted by that value. Accordingly, the total data center operating cost is about $1.20 M, the lowest noted.

The advantages of the other cases discussed in this disclosure, although not quantified in Table 3, provide similar compelling cost savings compared to the conventional approach.

BENEFITS TO THERMAL POWER STATION OWNER—The thermal power station owner can benefit from co-hosting the datacenter in several ways.

Long-term Power Contract—The ability of a station Owner to secure an extended power contract with a customer will assist in controlling and distributing fixed capital and operating costs. Although the details and form of the power sales agreement is beyond this discussion, and is not relevant to the idea of co-hosting the datacenter at a power station, one viable concept is to relate the power price to the fixed operations and maintenance costs, variable operations and maintenance costs, and fuel price, as well as the cost labor and other factors. This type of arrangement may be preferable to the concept of agreeing to a fixed or negotiated electric power price, in which a captive customer (the datacenter operator) does not have leverage in extending or altering the power sales agreement in the event that fuel prices or the plant utilization changes. Under this case, the host utility benefits by being able to spread fixed, operating, and variable non-fuel costs over addition sources.

Higher Minimum Load-Essentially all power stations experience a minimum generating load, usually during the midnight shift, or for example during periods such as from 12 PM-5 AM. The minimum load can range from only 60% of maximum capacity for relatively new, high efficiency baseload units, to less than 10% of maximum capacity for older, lower efficiency units that operate only in a “peaking” mode. Owners generally desire to have the highest minimum load possible—not only to derive higher power sales, but to avoid the constant cycling between maximum and minimum load, which induces thermal stress, reducing the lifetime of high pressure components. The load profile of a data center will increase the minimum load, which will reduce component stress.

Thermal Efficiency Improvements—The thermal efficiency of a plant depends on load—the highest boiler efficiencies can be achieved at peak load, with lower and particularly minimum load conditions contributing to thermal efficiency loss. The reduction in thermal efficiency can be due to two factors: (a) higher excess air level for firing fuel at low load, and (b) higher percentage consumption of auxiliary power by ancillary and support equipment.

Regarding (a), the degree of excess air used to fire fuel can increase as load decreases. This can be due to safety issues to insure a stable flame, as well as maintain a minimum mass flow rate through the boiler, for heat transfer purposes. As the boiler thermal efficiency is determined (among other factors) by the latent heat loss attributed to excess air, increasing this loss can lower thermal efficiency.

Regarding (b), ancillary equipment such as flue gas fans, boiler feedwater pumps, various drives for air dampers, and power consumed by environmental controls such as electrostatic precipitators and flue gas desulfurization equipment can consume significant auxiliary power, that is parasitic to high thermal efficiency. These components cannot always be turned down in precise increments that match the power output of the boiler. Thus, at lower load the sum of ancillary equipment can represent a higher fraction of the delivered load. As a hypothetical example, at full load parasitic consumption can represent 2-3% of delivered power; at 50% load this fraction can be disproportionately higher (e.g. 4-5%).

Finally, if the waste heat rejected by the data center can be delivered to a location such as the feedwater heater, or utilized to preheat boiler make-up water, or any of the other benefits described, the thermal power station will derive a thermal efficiency improvement.

LOW OR ZERO-CARBON FOOTPRINT DATACENTER OPERATIONS—The preceding description of integrating a datacenter into a power station to provide a near-zero or zero-carbon footprint operation could be comprised of the following.

First, any of the scenarios described previously defining how to integrate the data center with a power station can lower the carbon production of the cooling media, as described. For example, Scenario D can provide the opportunity to operate the datacenter cooling system with low carbon footprint; all cooling media required by the datacenter and the absorption chiller can be provided as a byproduct of power station operations, and the waste heat rejected by the datacenter can contribute to power station plant efficiency or power generation.

In this regard, it may be beneficial to locate the data center at, or adjacent to, the thermal power station to expeditiously and effectively provide for the synergies stated. For example, if cooling tower blowdown is used for data center cooling on a once-through basis, then the piping necessary to route the cooling tower blowdown to the data center and return to the plant for discharge may be minimized. One feasible way for this concept to work is to utilize the existing thermal plant discharge pond or containment, to minimize the piping and auxiliary power. Further, if the cooling tower blown is to be further reduced in temperature in summer months by an absorption chiller, piping and routing for the waste heat sources (water, steam or flue gas) to the absorption chiller may only be feasible for short distances. If the facilities are remote, the inherent heat loss incurred in transferring these sources of waste heat may compromise performance.

Similarly, the concept of using the waste heat rejected by the data center to augment power production or heat rate requires close-coupled equipment, as the inherent heat losses or auxiliary power requirements should be minimized so the concept is feasible.

The total contribution of datacenter operation to carbon emissions can be completely negated by firing the balance of the boiler with biomass. The utilization of biomass fuels for co-firing in steam boilers to avoid CO₂ production has been well-discussed, and many power companies in the various states considering renewable portfolio standards are exploring this option. It should be noted that co-firing of small amounts of biomass—for example, equal to 3-5% of the total heat input—can in many cases be accommodated without significant problems or cost. As described by in the report assessing the potential for the use of biomass fuels in North Carolina, this magnitude of co-firing may be technically feasible and not compromise plant operation (La Capra, 2006). Achieving a percent of biomass utilization greater than 3-5% may require additional investment in fuel processing and injection systems, or perhaps altering heat transfer surface area. Also, many types of biomass fuels are generally not widely available, and a demand for large quantities will increase the delivered price of this fuel. Further, the utilization of a greater fraction of biomass fuel may be prohibited by the potential of biomass to introduce alkaline and alkaline earth elements, which are known to poison the catalyst used in the environmental control option of selective catalytic reduction NOx control. Consequently, the feasibility of utilizing biomass fuels can be improved when the fraction of heat input fired is modest, such as 3-5% on average.

The utilization of the methods, systems and apparatus described in this disclosure, combined with firing the steam boiler by approximately 3-5% biomass, can constitute a feasible means to effect complete zero-carbon footprint of datacenter operation. For example, consider the case of a conventional datacenter that would require 5 MW of electrical power to operate the servers and an additional 5 MW of electrical power of cooling, that employs this approach. Consequently, the 5 MW electrical requirement for cooling would not be necessary, by the applying means described in this provisional disclosure. Thus, for an exemplary 200 MW host plant, the data center would require solely the 5 MW of power from biomass—for this case, 2.5% of the power output. This would correspond to about the same fraction—2.5%—for the heat input. Although in concept the host steam boiler could fire up to 25 MW of output with biomass, the limited accessibility of biomass fuels and their higher cost resulting in higher power generation cost presents an unfavorable situation for co-hosting. Reducing the amount of biomass required to negate CO₂ emissions by, in this example, approximately one-half presents a good opportunity to completely negate CO₂ from data center operations while maintaining a profitable enterprise for both the datacenter owner and power station owner.

The following references are incorporated herein by reference in their entireties:

| CITATION | REFERENCE |
|---|---|
| DOE, 2002 | U.S. Department of energy, “Gas-Fired Distributed |
| | Energy Resource Technology Characterization”, |
| | prepared by the National Renewable Energy |
| | Technology Laboratory, November, 2003, Report |
| | NREL/TP-620-34783 |
| DOE Tech Brief | U.S. Department of Energy, “Thermally-Activated |
| | Absorption Chillers”, Tech Brief, Distributed Energy |
| | and Electric Reliability Program, Office of Energy |
| | Efficient and Renewable Energy, available from |
| | www.eren.doe.gov |
| DOE Energy | U.S. Department of Energy, “Steam Tip Sheet #14, |
| Tips, 2006 | Use of Low-Grade Waste Heat to Power Absorption |
| | Chillers”, Office of Energy Efficient and Renewable |
| | Energy, available from www.eren.doe.gov, January |
| | 2006. |
| EPA, 2007 | Environmental Protection Agency, “Report to |
| | Congress on Server and Data Center Efficiency: |
| | Public Law 109-431”, Aug. 2, 2007 |
| IDG, 2007 | IDG News Services, “Tech's Own Data Centers are |
| | Their Green Showrooms”, ITworld.com, Aug. 21, |
| | 2007. |
| Koomey, 2007 | Koomey, J., “Estimating Total Power Consumption |
| | by Servers in The U.S. and World, final report |
| | prepared for the Lawrence Berkeley National |
| | Laboratory, |
| La Capra, 2006 | La Capra Associates, et. al., “Analysis of a |
| | Renewable Portfolio Standard for the State of North |
| | Carolina”, technical reported prepared for the North |
| | Carolina Utilities Commission, December, 2006 |

The foregoing exemplary embodiments have been provided for the purpose of explanation and are in no way to be construed as limiting this disclosure. This disclosure is not limited to the particulars disclosed herein, but extends to all embodiments within the scope of the appended claims, and any equivalents thereof.

1. A method of cooling a data center, comprising:
diverting a portion of cooling water acquired by a thermal power station intake structure from a body of water; and
passing the diverted portion of cooling water through at least one heat exchanger to cool heat rejected by at least one data center.

2. The method of claim 1, wherein the diverting is only conducted when a cooling water flow rate or temperature prior to the diverting is in excess of what is required for a boiler condenser to which a non-diverted portion of the cooling water is sent.

3. The method of claim 1, wherein the at least one heat exchanger is at least one direct heat exchanger, where surfaces of the heat exchanger that reject data center heat are in direct contact with the diverted cooling water

4. The method of claim 1, wherein the at least one heat exchanger is at least one indirect heat exchanger, wherein surfaces of the heat exchanger that reject data center heat are in contact with a cooling media or cooling fluid that flows in a closed loop through a second heat exchanger, the diverted cooling water flowing through the second heat exchanger.

5. The method of claim 1, wherein the diverting is only conducted during a portion of a year when the temperature of the cooling water to be diverted is less than a selected temperature to provide for data center cooling, utilizing either a direct or indirect heat exchanger; and during other portions of the year, when the temperature is above the selected temperature, the heat rejected by the at least one data center is cooled in a different manner.

6. The method of claim 1, further comprising diverting the cooling water to at least one heat exchanger from an absorption chiller that utilizes as a heat source at least one of steam, heated water, and flue gas from combustion products, to remove heat from the at least one data center.

7. The method of claim 1, wherein, at times when the temperature of the water acquired by the thermal power station inlet structure is sufficient in a direct or indirect heat exchanger, said temperature of the water being of a maximum of 75° F., and when the temperature of the water exceeds approximately 75° F., the water then used to accept heat rejected by an absorption chiller, configured to provide the cooling water to the data center.

8. The method of claim 1 wherein the thermal power station is a coal-fired thermal power station.

9. The method of claim 1 wherein the thermal power station is a fossil fuel-fired, renewable fuel-fired, geothermal, or nuclear fuel thermal power station.

10. A method of cooling a data center, comprising sending heat removed from a data center by an absorption chiller utilizing at least one heat exchanger to transfer heat to raise the temperature of steam boiler condensate water, said heat exchanger located following a boiler condenser and preceding an inlet to the boiler feedwater; and thereafter recycling the heat removed from the data center to the steam boiler for power generation.

11. A method of cooling a data center, comprising sending heat removed from a data center by an absorption chiller to either the effluent or inlet to the cooling tower, or an ancillary heat exchanger at a power plant site in contact with a cooling water body or another thermal generating unit at the power plant site.

12. A method of cooling a data center, comprising sending heat removed from a data center by an absorption chiller to either effluent or inlet to a cooling tower, or a heat exchanger in contact with cooling water located downstream of a boiler condenser.

13. A method of cooling a data center, comprising;
utilizing a cooling tower configured for a thermal power station; and
diverting cooling tower blowdown to the data center for cooling;
utilizing either a direct heat exchanger on a once-through basis, or an indirect heat exchanger, with data center cooling provided by a recirculating cooling media and a second heat exchanger; and
rejecting the cooling tower blowdown to the plant discharge pond or impoundment system.

14. The method of claim 13, further comprising:
cooling the cooling tower blowdown with an absorption chiller, or utilizing cooling water chilled by the absorption chiller to supplement the cooling tower blowdown, the absorption chiller driven by steam or heated water or flue gas from the thermal power station; and
rejecting heat to a stream either entering to or exiting from the cooling tower, or an ancillary heat exchanger in contact with a cooling water body.

15. The method of claim 13, further comprising:
cooling the cooling tower blowdown with an absorption chiller, or utilizing cooling water chilled by the absorption chiller to supplement the cooling tower blowdown, the absorption chiller driven by steam or heated water or flue gas from the thermal power station, and rejects heat to the condenser section or other heat exchangers of the steam boiler, the latter in a manner to return said heat to the steam cycle to contribute to power generation or unit thermal efficiency.

16. A method of cooling a data center, comprising;
utilizing a cooling tower configured for a power station; and
diverting a cooling stream or effluent from the cooling tower in transit to a boiler, when the marginal benefit provided by this quantity of cooling water in minimizing backpressure within the boiler condenser to improve plant output and thus thermal efficiency is small or counterproductive, or when said cooling water from the cooling tower is in excess in flow volume and/or temperature of what is required for the boiler condenser, said diverted cooling water utilized in at least one either direct or indirect heat exchanger to remove the heat rejected by a data center, this method minimizing or eliminating the penalty to thermal performance or output of the power station.

17. The method of claim 16, further comprising:
lowering the temperature of the cooling stream or effluent from the cooling tower with an absorption chiller that is driven by steam or heated water or flue gas from the thermal power station, or utilizing cooling water chilled by the absorption chiller to supplement the cooling tower effluent; and
rejecting heat either to the cooling tower, or an ancillary heat exchanger at the plant site in contact with a cooling water body.

18. The method of claim 16, further comprising:
chilling the cooling tower effluent with an absorption chiller that is driven by steam or heated water or flue gas from the thermal power station, or utilizing cooling water chilled by the absorption chiller to supplement the cooling tower effluent; and
rejecting heat to the condenser section or other heat exchangers of the steam boiler, the latter in a manner to return this heat to the steam cycle to contribute to power generation or unit thermal efficiency.

19. The method of claim 16, further comprising cooling the cooling tower effluent with an absorption chiller that is driven by steam or heated water or flue gas from the thermal power station, and rejecting heat to an ancillary heat exchanger located following the boiler condenser section.

20. A method of cooling a data center, comprising:
utilizing a cooling tower configured for a power station, and diverting a portion of make-up water intended for the cooling tower to the data center for cooling, when the marginal benefit provided by the performance of the cooling tower in minimizing cooling water effluent temperature in minimizing backpressure within the boiler condenser to improve plant output and thus thermal efficiency is small or counterproductive, or when said cooling water flow rate and/or temperature from the cooling tower is in excess of what is required for the boiler condenser, said diverted cooling tower make-up water utilized in at least one either direct or indirect heat exchanger to cool the heat rejected by a data center, this method minimizing or eliminating the penalty to thermal performance or output of the power station.

21. The method of claim 20, further comprising cooling the cooling tower make-up stream in transit to the data center with an absorption chiller that is driven by steam or heated water or flue gas from the thermal power station, or utilizing cooling water chilled by the absorption chiller to supplement the cooling tower make-up stream, and rejecting heat either to the cooling tower, or any existing ancillary heat exchanger at the plant site in contact with a cooling water body or another thermal generating unit at the same station.

22. The method of claim 20, further comprising cooling the cooling tower make-up stream in transit to the data center with an absorption chiller that is driven by steam or heated water or flue gas from the thermal power station, or utilizing the cooling water chilled by the absorption chiller to supplement the cooling tower make-up stream, and rejecting heat to a condenser section or one or more additional heat exchangers following the condenser section and preceding the inlet to the steam boiler, the latter in a manner to return heat to a steam cycle to contribute to one or both of power generation and unit thermal efficiency.

23. A method of providing cooling water for a data center, that uses the boiler make-up water from a nearby thermal power station, such boiler make-up water provided by a conventional source, and diverts such make-up water either through a direct or indirect heat exchanger, to provide water that cools the data center, and is returned as make-up water to the boiler, improving boiler thermal efficiency due to the heat added by the data center.

24. The method of claim 23, where the boiler make-up water is heated prior to the plant treatment or purification system, and by heating the water entering the treatment equipment, improving the treatment system capability in terms of the degree of reduction of trace species, or achieving a given level of trace species reduction with process chemicals, reagents or consumption of power.

25. A combination of a data center and a power-producing plant, comprising:
a data center that produces heat;
a power-producing plant that produces heat and has a source of water;
an apparatus for transferring heat from the data center to the power-producing plant by heating a portion of the source of water with heat from the data center and transferring the water after the heating back to the power-producing plant.

26. A system for cooling a data center, comprising:
at least one data center;
a thermal power station;
a cooling water source, the source selected from at least one of: a cooling water body, a lake, a river, an ocean, or a cooling tower with effluent and inlet streams of cooling water, cooling tower blowdown, and cooling tower make-up;
at least one, or at least both, a direct and an indirect heat exchanger;
at least one absorption chiller;
wherein, only over a portion of a year, the cooling water alone is utilized to cool heat rejected by the at least one data center, in conjunction with the at least one, or at least both, heat exchanger;
and during other portions of the year, the absorption chiller either augments or replaces the cooling water to cool heat rejected by the at least one data center, in conjunction with the at least one or at least both heat exchanger, and where the system is configured to put the rejected heat in the cooling body or cooling tower or the boiler water after it passes through a condenser.
